(19) United States
(12) Patent Application Publication
(10) Pub. No.: US 2008/0320209 A1
(43) Pub. Date: Dec. 25, 2008

(54) High Performance and Endurance Non-volatile Memory Based Storage Systems

(75) Inventors: Charles C. Lee, Cupertino, CA (US); I-Kang Yu, Palo Alto, CA (US); Abraham Chih-Kang Ma, Fremont, CA (US); David Q. Chow, San Jose, CA (US); Ming-Shiang Shen, Hsin Chuang (TW)

Correspondence Address: ROGER H. CHU, 19499 ERIC DRIVE, SARATOGA, CA, 95070, US

(73) Assignee: Super Talent Electronics, Inc., San Jose, CA (US)

(21) Appl. No.: 12/141,879

(22) Filed: Jun. 18, 2008

Related U.S. Application Data
(63) Continuation-in-part of application No. 12/054,310, filed on Mar. 24, 2008.
Application No. 12/054,310 is a continuation-in-part of application No. 12/035,398, filed on Feb. 21, 2008.
Application No. 12/035,398 is a continuation-in-part of application No. 11/770,642, filed on Jun. 28, 2007.
Application No. 11/770,642 is a continuation-in-part of application No. 11/748,595, filed on May 15, 2007.
Application No. 11/748,595 is a continuation-in-part of application No. 10/818,653, filed on Apr. 5, 2004, now Pat. No. 7,243,185.
Application No. 10/818,653 is a continuation-in-part of application No. 12/115,128, filed on May 5, 2008.
Application No. 12/115,128 is a continuation-in-part of application No. 12/017,249, filed on Jan. 21, 2008.
Application No. 12/017,249 is a continuation-in-part of application No. 12/025,706, filed on Feb. 4, 2008.
Application No. 12/025,706 is a continuation-in-part of application No. 11/871,011, filed on Oct. 11, 2007.
Application No. 11/871,011 is a continuation-in-part of application No. 12/128,916, filed on May 29, 2008.
Application No. 12/128,916 is a continuation of application No. 11/309,594, filed on Aug. 28, 2006, now Pat. No. 7,383,362.
Application No. 11/309,594 is a continuation-in-part of application No. 10/707,277, filed on Dec. 2, 2003, now Pat. No. 7,103,684.
Application No. 10/707,277 is a continuation-in-part of application No. 11/458,987, filed on Jul. 20, 2006.
Application No. 11/458,987 is a continuation-in-part of application No. 09/478,720, filed on Jan. 6, 2000, now Pat. No. 7,257,714.
Application No. 09/478,720 is a continuation-in-part of application No. 10/761,853, filed on Jan. 20, 2004, now abandoned.
Application No. 10/761,853 is a continuation-in-part of application No. 12/099,421, filed on Apr. 8, 2008.
Application No. 12/099,421 is a continuation-in-part of application No. 11/624,667, filed on Jan. 18, 2007.
Application No. 11/624,667 is a division of application No. 09/478,720, filed on Jan. 6, 2000, now Pat. No. 7,257,714.

(51) Int. Cl. G06F 12/02; G06F 12/00

(52) U.S. Cl. 711/103; 711/166; 711/E12.001; 711/E12.008

(57) ABSTRACT

High performance and endurance non-volatile memory (NVM) based storage systems are disclosed. According to one aspect of the present invention, a NVM based storage system comprises at least one intelligent NVM device. Each intelligent NVM device includes a control interface logic and NVM. Logical-to-physical address conversion is performed within the control interface logic, thereby eliminating the need of address conversion in a storage system level controller. In another aspect, a volatile memory buffer together with corresponding volatile memory controller and phase-locked loop circuit is included in a NVM based storage system. The volatile memory buffer is partitioned to two parts: a command queue; and one or more page buffers. The command queue is configured to hold received data transfer commands by the storage protocol interface bridge, while the page buffers are configured to hold data to be transmitted between the host computer and the at least one NVM device.

### CROSS-REFERENCE TO RELATED APPLICATIONS

This application is a continuation-in-part (CIP) of U.S. patent application for “High Integration of Intelligent Non-Volatile Memory Devices”, Ser. No. 12/054,310, filed Mar. 24, 2008, which is a CIP of “High Endurance Non-Volatile Memory Devices”, Ser. No. 12/035,398, filed Feb. 21, 2008, which is a CIP of “High Speed Controller for Phase Change Memory Peripheral Devices”, U.S. application Ser. No. 11/770,642, filed on Jun. 28, 2007, which is a CIP of “Local Bank Write Buffers for Acceleration a Phase Change Memory”, U.S. application Ser. No. 11/748,595, filed May 15, 2007, which is CIP of “Flash Memory System with a High Speed Flash Controller”, application Ser. No. 10/818,653, filed Apr. 5, 2004, now U.S. Pat. No. 7,243,185.

This application is also a CIP of U.S. patent application for “Intelligent Solid-State Non-Volatile Memory Device (NVMD) System with Multi-Level Caching of Multiple Channels”, Ser. No. 12/115,128, filed on May 5, 2008.

This application is also a CIP of U.S. patent application for “High Performance Flash Memory Devices”, Ser. No. 12/017,249, filed on Feb. 27, 2008.

This application is also a CIP of U.S. patent application for “Method and Systems of Managing Memory Addresses in a Large Capacity Multi-Level Cell (MLC) based Memory Device”, Ser. No. 12/025,706, filed on Feb. 4, 2008, which is a CIP application of “Flash Module with Plane-interleaved Sequential Writes to Restricted-Write Flash Chips”, Ser. No. 11/871,011, filed Oct. 11, 2007.

This application is also a CIP of U.S. patent application for “Single-Chip Multi-Media Card/Secure Digital controller Reading Power-on Boot Code from Integrated Flash Memory for User Storage”, Ser. No. 12/128,916, filed on May 29, 2008, which is a continuation of U.S. patent application for the same title, Ser. No. 11/309,594, filed on Aug. 28, 2006, now issued as U.S. Pat. No. 7,383,362 on Jun. 3, 2008, which is a CIP of U.S. patent application for “Single-Chip USB Controller Reading Power-On Boot Code from Integrated Flash Memory for User Storage”, Ser. No. 10/707,277, filed on Dec. 2, 2003, now issued as U.S. Pat. No. 7,103,684.

This application is also a CIP of U.S. patent application for “Electronic Data Flash Card with Fingerprint Verification Capability”, Ser. No. 11/458,987, filed Jul. 20, 2006, which is a CIP of U.S. patent application for “Highly Integrated Mass Storage Device with an Intelligent Flash Controller”, Ser. No. 10/761,853, filed Jan. 20, 2004, now abandoned.

This application is also a CIP of U.S. patent application for “flash memory devices with security features”, Ser. No. 12/099,421, filed on Apr. 8, 2008.

This application is also a CIP of U.S. patent application for “Electronic Data Storage Medium with Fingerprint Verification Capability”, Ser. No. 11/624,667, filed on Jan. 18, 2007, which is a divisional of U.S. patent application Ser. No. 09/478,720, filed on Jan. 6, 2000, now U.S. Pat. No. 7,257,714 issued on Aug. 14, 2007.

This application may be related to a U.S. Pat. No. 7,073,010 for “USB Smart Switch with Packet Re-Ordering for Interleaving among Multiple Flash-Memory Endpoints Aggregated as a Single Virtual USB Endpoint” issued on Jul. 4, 2006.

### FIELD OF THE INVENTION

The invention relates to data storage using non-volatile memory (NVM), more particularly to high performance and endurance NVM based storage systems.

### BACKGROUND OF THE INVENTION

Traditionally, hard disk drives have been used as data storage in a computing device. With advance of non-volatile memory (e.g., NAND flash memory), some attempts have been made to use non-volatile memory as the data storage.

Advantages of using NAND flash memory as data storage over hard disk drive are as follows:
(1) No moving parts;
(2) No noise or vibration caused by the moving parts;
(3) Higher shock resistance;
(4) Faster startup (i.e., no need to wait for spin-up to steady state);
(5) Faster random access;
(6) Faster boot and application launch time; and
(7) Lower read and write latency (i.e., seek time).

However, there are shortcomings of using non-volatile memory as data storage. First problem is related to performance, NAND flash memory can only be accessed (i.e., read and/or programmed(written)) in data chunks (e.g., 512-byte data sector) instead of bytes. In addition, NAND flash memory needs to be erased before any new data can be written into, and data erasure operations can only be carried out in data blocks (e.g., 128 k-byte, 256 k-byte, etc.). All of the valid data in a data block must be copied to a new allocated block before any erasure operation thereby causing performance slow down. The characteristics of data programming and erasure not only makes NAND flash memory cumbersome to control (i.e., requiring a complex controller and associated firmware), but also difficult to realize the advantage of higher accessing speed over the hard disk drive (e.g., frequent out-of sequence updating in a file may result into many repeated data copy/erasure operations).

Another problem in NAND flash memory relates to endurance. Unlike hard disk drives, NAND flash memories have a life span measuring by limited number of erasure/programming cycles. As a result, one key goal of using NAND flash memories as data storage to replace hard disk drives is to avoid data erasure/programming as much as possible.

It would be desirable, therefore, to have an improved non-volatile memory based storage system that can overcome shortcomings described herein.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

High performance and endurance non-volatile memory (NVM) based storage systems are disclosed. According to one aspect of the present invention, a NVM based storage system comprises at least one intelligent NVM device, an internal bus, at least one intelligent NVM device controller, a hub timing controller, a central processing unit, a data dispatcher and a storage protocol interface bridge. The intelligent NVM device includes a control interface logic and NVM. The control interface logic is configured to receive commands, logical addresses, data and timing signals from corresponding one of the at least one intelligent NVM device controller. Logical-to-physical address conversion can be performed within the control interface logic, thereby eliminating the need of address conversion in a storage system level controller (e.g., NVM based storage system). This feature also enables distributed address mappings instead of centralized prior art approaches. The data dispatcher together with the hub timing controller is configured for dispatching commands and sending relevant timing clock cycle to each of the at least one NVM device controller via the internal bus to enable interleaved parallel data transfer operations. The storage protocol interface bridge is configured for receiving data transfer commands from a host computer system via an external storage interface. An intelligent NVM device can be implemented as a single chip, which may include, but not be limited to, a product-in-package, a device-on-device package, a device-on-silicon package, or a multi-die package.

According to another aspect of the present invention, a volatile memory buffer together with corresponding volatile memory controller and phase-locked loop (PLL) circuit is also included in a NVM based storage system. The volatile memory buffer is partitioned to two parts: a command queue and one or more page buffers. The command queue is configured to hold received data transfer commands received by the storage protocol interface bridge, while the page buffers are configured to hold transition data to be transmitted between the host computer and the at least one NVM device. PLL circuit is configured for providing timing clock to the volatile memory buffer.

According to yet another aspect of the present invention, the volatile memory buffer allows data write commands with overlapped target address to be merged in the volatile memory buffer before writing to the at least one NVM device, thereby reducing repeated data programming or writing into same area of the NVM device. As a result, endurance of the NVM based storage system is increased due to less numbers of data programming.

According to yet another aspect, the volatile memory buffer allows preloading of data to anticipate requested data in certain data read commands hence increasing performance of the NVM based storage system.

According to yet another aspect, when a volatile memory buffer is included in a NVM based storage system, the system needs to monitor unexpected power failure. Upon detecting such power failure, the stored commands in the command queue along with the data in the page buffers must be stored in a special location using reserved electric energy stored in a designated capacitor. The special location is a reserved area of the NVM device, for example, the last physical block of the NVM device. The command queue is so sized that limited amount of electric energy stored in the designated capacitor can be used for copying all of the stored data to the reserved area. In order to further maximize the capacity of the command queue, emergency data dump is performed without address conversion.

According to still another aspect, after unexpected power failure, a NVM based storage system can restore its volatile memory buffer by copying the data from the reserved area of the NVM to the volatile memory buffer.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a block diagram showing salient components of a first flash memory device (with fingerprint verification capability), in which an embodiment of the present invention may be implemented;

FIG. 1B is a block diagram showing salient components of a second flash memory device (without fingerprint verification capability), in which an embodiment of the present invention may be implemented;

FIG. 1C is a block diagram showing salient components of a flash memory system embedded on a motherboard, in which an embodiment of the present invention may be implemented;

FIG. 1D is a block diagram showing salient components of a flash memory module coupling to a motherboard, in which an embodiment of the present invention may be implemented;

FIG. 1E is a block diagram showing salient components of a flash memory module without a controller, the flash memory module couples to a motherboard, in which an embodiment of the present invention may be implemented;

FIG. 2A is a block diagram depicting salient components of a first exemplary non-volatile memory (NVM) based storage system, according one embodiment of the present invention;

FIG. 2B is a block diagram depicting salient components of a second exemplary NVM based storage system, according one embodiment of the present invention;

FIG. 2C is a block diagram depicting salient components of a third exemplary NVM based storage system, according one embodiment of the present invention;

FIG. 2D is a block diagram depicting salient components of a fourth exemplary NVM based storage system, according one embodiment of the present invention;

FIG. 2E-1 is a block diagram showing exemplary block access interface signals used in the NVM based storage system of FIG. 2A

FIG. 2E-2 is a block diagram showing exemplary synchronous DDR interlock signals used in the NVM based storage system of FIG. 2B;

FIG. 2F is a functional block diagram showing the exemplary DDR channel controller in the NVM based storage system of FIG. 2B;

FIG. 2G is a functional block diagram showing the exemplary DDR control interface and NVM in the NVM based storage system of FIG. 2B;

FIG. 2H is a flowchart illustrating an exemplary process of encrypting plain text data using an data encryption/decryption engine based on 128-bit Advanced Encryption Standard (AES) in accordance with one embodiment of the present invention;

FIG. 3 is a block diagram illustrating salient components of an exemplary dual-mode NVM based storage device;

FIG. 4A is a diagram showing an exemplary intelligent non-volatile memory device controller for single channel intelligent NVMD array in accordance with one embodiment of the present invention;

FIG. 4B is a diagram showing an exemplary intelligent non-volatile memory device controller for multiple channel interleaved intelligent NVMD array in accordance with one embodiment of the present invention;

FIG. 5A is a block diagram showing data structure of host logical address, NVM physical address and volatile memory buffer, according to one embodiment of the present invention;

FIG. 5B is a block diagram showing data structure used in intelligent NVMD of FIG. 2B, according to an embodiment of the present invention;

FIG. 5C is a block diagram showing exemplary data structure of command queue and a page buffer configured in volatile memory buffer, according to an embodiment of the present invention;

FIG. 6A is a timeline showing time required for writing one page of data to NVM in a NVM based storage system without a volatile memory buffer support;

FIG. 6B is a timeline showing time required for writing one page of data to NVM in a NVM based storage system without a volatile memory buffer support, when a bad block is encountered;

FIG. 6C is a timeline showing time required for performing burst write to a volatile memory buffer and then to an intelligent NVM device when command queue is full under normal operation;

FIG. 6D is a timeline showing time required for performing burst write to a volatile memory buffer and then to an intelligent NVM device after unexpected power failure has been detected;

FIGS. 7A-B collectively are a flowchart illustrating an exemplary process of performing data transfer in the NVM based storage system of FIG. 2B, according to an embodiment of the present invention;

FIG. 8 is a flowchart illustrating an exemplary process of using a volatile memory buffer in the NVM based storage system of FIG. 2B, according to another embodiment of the present invention;

FIG. 9 is a flowchart illustrating an exemplary process of performing direct memory access operation in the NVM based storage system of FIG. 2B, according to an embodiment of the present invention;

FIG. 10 is a flowchart illustrating a first exemplary process after unexpected power failure has been detected in the NVM based storage system of FIG. 2B, according to an embodiment of the present invention;

FIG. 11 is a flowchart illustrating a second exemplary process after detecting an unexpected power failure in the NVM based storage system of FIG. 2B, according to an embodiment of the present invention;

FIG. 12 is a flowchart illustrating an exemplary process of restoring volatile memory buffer of the NVM based storage system of FIG. 2B after an unexpected power failure, according to an embodiment of the present invention;

FIG. 13A is a waveform diagram showing time required for performing data write operation from the volatile memory buffer to the intelligent NVM device in the NVM based storage system of FIG. 2A; and

FIG. 13B is a waveform diagram showing time required for performing data write operation from the volatile memory (i.e., double data rate synchronous dynamic random access memory) buffer to the intelligent NVM device in the NVM based storage system of FIG. 2B.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

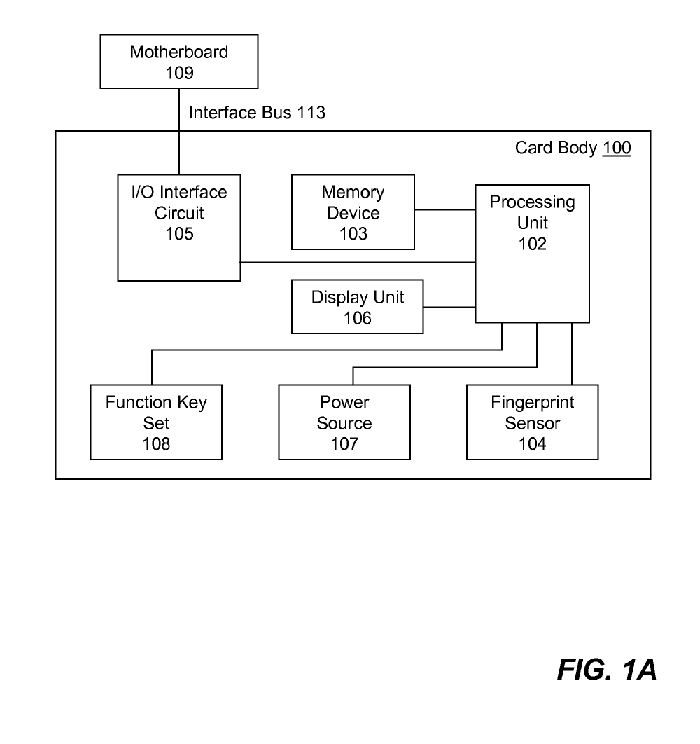

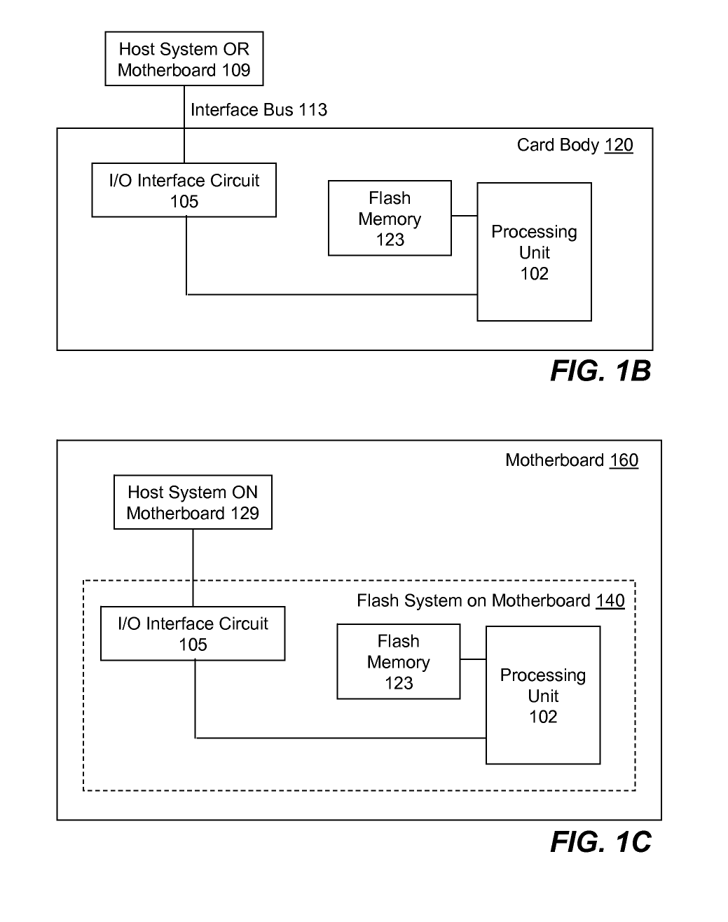

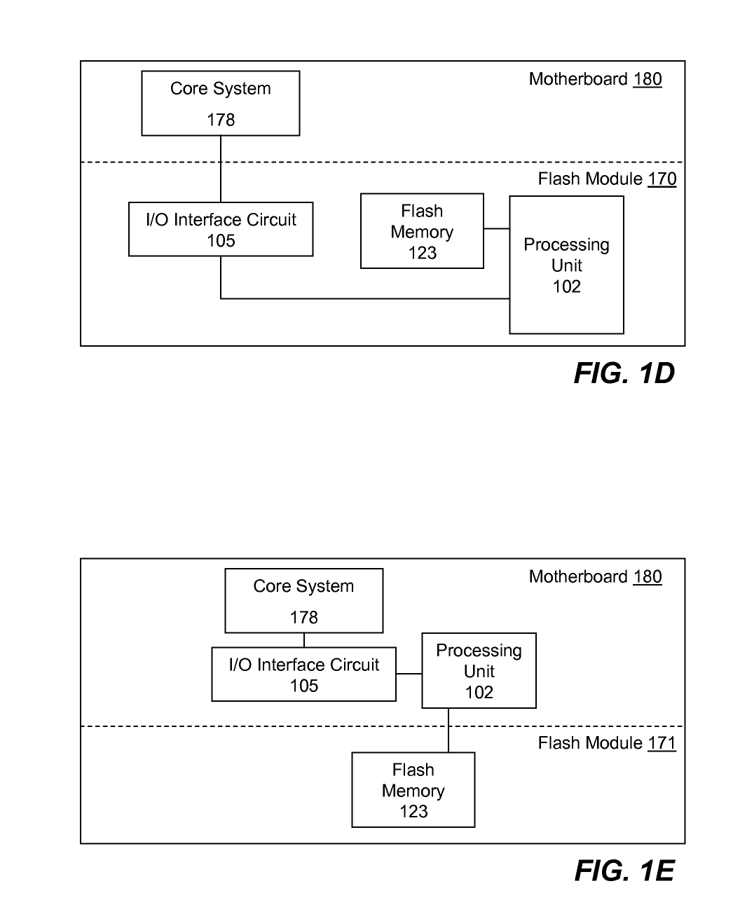

Embodiments of the present invention are discussed herein with reference to FIGS. 1A-13B. However, those skilled in the art will readily appreciate that the detailed description given herein with respect to these figures is for explanatory purposes as the invention extends beyond these limited embodiments.

FIG. 1A is a block diagram illustrating salient components of a first flash memory device (with fingerprint verification capability), in which an embodiment of the present invention may be implemented. The first flash memory device is adapted to a motherboard 109 via an interface bus 113. The first flash memory device includes a card body 100, a processing unit 102, memory device 103, a fingerprint sensor 104, an input/output (I/O) interface circuit 105, an optional display unit 106, an optional power source (e.g., battery) 107, and an optional function key set 108. The motherboard 109 may be a motherboard of a desktop computer, a laptop computer, a mother board of a personal computer, a cellular phone, a digital camera, a digital camcorder, a personal multimedia player or any other computing or electronic devices.

The card body 100 is configured for providing electrical and mechanical connection for the processing unit 102, the memory device 103, the I/O interface circuit 105, and all of the optional components. The card body 100 may comprise a printed circuit board (PCB) or an equivalent substrate such that all of the components as integrated circuits may be mounted thereon. The substrate may be manufactured using surface mount technology (SMT) or chip on board (COB) technology.

The processing unit 102 and the I/O interface circuit 105 are collectively configured to provide various control functions (e.g., data read, write and erase transactions) of the memory device 103. The processing unit 102 may also be a standalone microprocessor or microcontroller, for example, an 8051, 8052, or 80286 Intel® microprocessor, or ARM®, MIPS® or other equivalent digital signal processor. The processing unit 102 and the I/O interface circuit 105 may be made in a single integrated circuit, for application specific integrated circuit (ASIC).

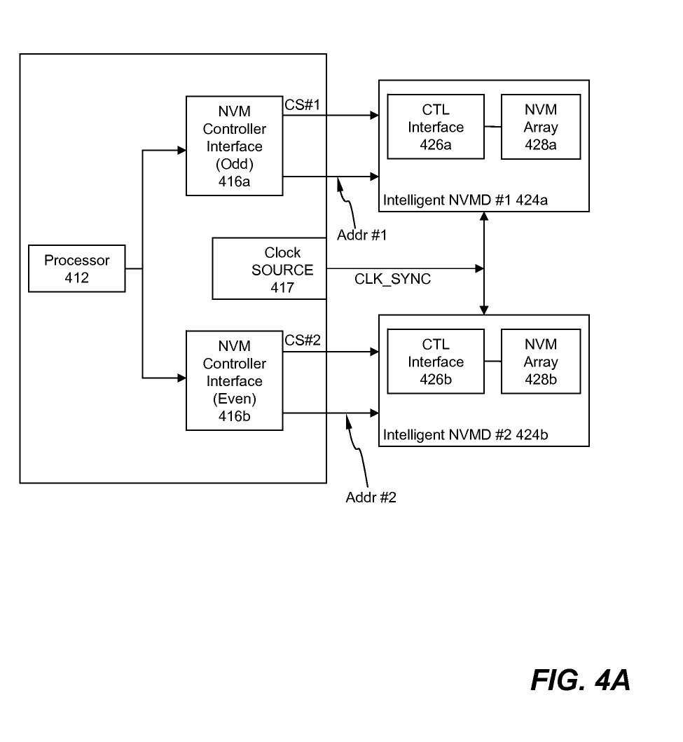

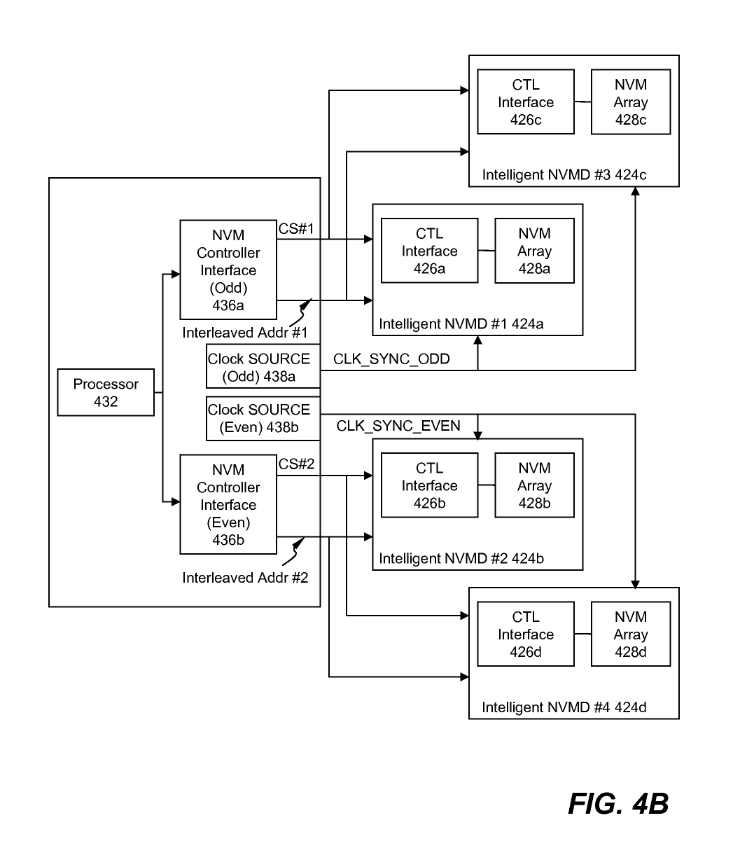

The memory device 103 may comprise one or more non-volatile memory (e.g., flash memory) chips or integrated circuits. The flash memory chips may be single-level cell (SLC) or multi-level cell (MLC) based. In SLC flash memory, each cell holds one bit of information, while more than one bit (e.g., 2, 4 or more bits) are stored in a MLC flash memory cell. A detail data structure of an exemplary flash memory is described and shown in FIG. 4A and corresponding descriptions thereof.

The fingerprint sensor 104 is mounted on the card body 100, and is adapted to scan a fingerprint of a user of the first electronic flash memory device 100 to generate fingerprint scan data. Details of the fingerprint sensor 104 are shown and described in a co-inventor's U.S. Pat. No. 7,257,714, entitled “Electronic Data Storage Medium with Fingerprint Verification Capability” issued on Aug. 14, 2007, the entire content of which is incorporated herein by reference.

The memory device 103 stores, in a known manner therein, one or more data files, a reference password, and the fingerprint reference data obtained by scanning a fingerprint of one or more authorized users of the first flash memory device. Only authorized users can access the stored data files. The data file can be a picture file, a text file or any other file. Since the electronic data storage compares fingerprint scan data obtained by scanning a fingerprint of a user of the device with the fingerprint reference data in the memory device to verify if the user is the assigned user, the electronic data storage can only be used by the assigned user so as to reduce the risks involved when the electronic data storage is stolen or misplaced.

The input/output interface circuit 105 is mounted on the card body 100, and can be activated so as to establish communication with the motherboard 109 by way of an appropriate socket via an interface bus 113. The input/output interface circuit 105 may include circuits and control logic associated with a Universal Serial Bus (USB) interface structure that is connectable to an associated socket connected to or mounted on the motherboard 109. The input/output interface circuit 105 may also be other interfaces including, but not limited to, Secure Digital (SD) interface circuit, Micro SD interface circuit, Multi-Media Card (MMC) interface circuit, Compact Flash (CF) interface circuit, Memory Stick (MS) interface circuit, PCI-Express interface circuit, a Integrated Drive Electronics (IDE) interface circuit, Serial Advanced Technology Attachment (SATA) interface circuit, external SATA, Radio Frequency Identification (RFID) interface circuit, fiber channel interface circuit, optical connection interface circuit.

The processing unit 102 is controlled by a software program module (e.g., a firmware (FW)), which may be stored partially in a ROM (not shown) such that processing unit 102 is operable selectively in: (1) a data programming or write mode, where the processing unit 102 activates the input/output interface circuit 105 to receive data from the motherboard 109 and/or the fingerprint reference data from fingerprint sensor 104 under the control of the motherboard 109, and store the data and/or the fingerprint reference data in the memory device 103; (2) a data retrieving or read mode, where the processing unit 102 activates the input/output interface circuit 105 to transmit data stored in the memory device 103 to the motherboard 109; or (3) a data resetting or erasing mode, where data in stale data blocks are erased or reset from the memory device 103. In operation, motherboard 109 sends write and read data transfer requests to the first flash memory device 100 via the interface bus 113, then the input/output interface circuit 105 to the processing unit 102, which in turn utilizes a flash memory controller (not shown or embedded in the processing unit) to read from or write to the associated at least one memory device 103. In one embodiment, for further security protection, the processing unit 102 automatically initiates an operation of the data resetting mode upon detecting a predefined time period has elapsed since the last authorized access of the data stored in the memory device 103.

The optional power source 107 is mounted on the card body 100, and is connected to the processing unit 102 and other associated units on card body 100 for supplying electrical power (to all card functions) thereto. The optional function key set 108, which is also mounted on the card body 100, is connected to the processing unit 102, and is operable so as to initiate operation of processing unit 102 in a selected one of the programming, data retrieving and data resetting modes. The function key set 108 may be operable to provide an input password to the processing unit 102. The processing unit 102 compares the input password with the reference password stored in the memory device 103, and initiates authorized operation of the first flash memory device 100 upon verifying that the input password corresponds with the reference password. The optional display unit 106 is mounted on the card body 100, and is connected to and controlled by the processing unit 102 for displaying data exchanged with the motherboard 109.

A second flash memory device (without fingerprint verification capability) is shown in FIG. 1B. The second flash memory device includes a card body 120 with a processing unit 102, an I/O interface circuit 105 and at least one flash memory chip 123 mounted thereon. Similar to the first flash memory device, the second flash memory device couples to a motherboard or a host computing system 109 via an interface bus 113. Fingerprint functions such as scanning and verification may be handled by the host system 109.

FIG. 1C shows a flash memory system 140 integrated with a motherboard 160. Substantially similar to the second flash memory device 120 for FIG. 1B, the flash system 140 contains a processing unit 102, an I/O interface circuit 105 and at least one flash memory chip 123. Included on the motherboard 160, there is a host system 129 and the flash system 140. Data, command and control signals for the flash system 140 are transmitted through an internal bus.

FIG. 1D shows a flash memory module 170 coupling to a motherboard 180. The flash memory module 170 comprises a processing unit 102 (e.g., a flash controller), one or more flash memory chips 123 and an I/O interface circuit 105. The motherboard 180 comprises a core system 178 that may include CPU and other chip sets. The connection between the motherboard and the flash memory module 170 is through an internal bus such as a Peripheral Component Interconnect Express (PCI-E).

Another flash memory module 171 is shown in FIG. 1E. The device 171 comprised only flash memory chips or integrated circuits 123. Processing unit 102 (e.g., a flash memory controller) and I/O interface circuit 105 are built onto a motherboard 180 along with a core system 178 (i.e., a CPU and other chip sets). In a slight alternative embodiment, the processing unit 102 may be included in the CPU of the core system 178.

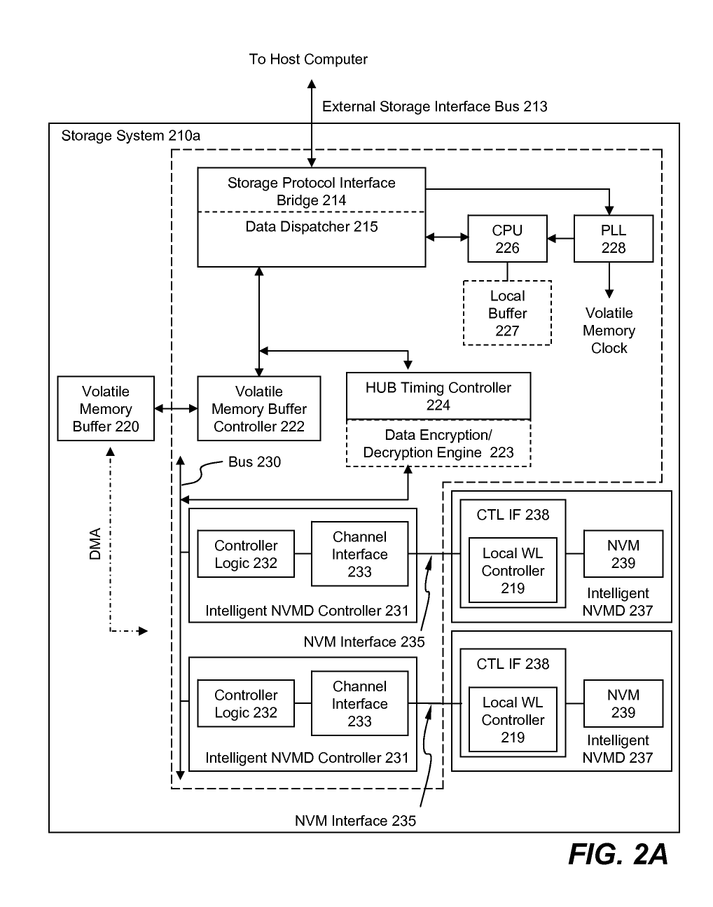

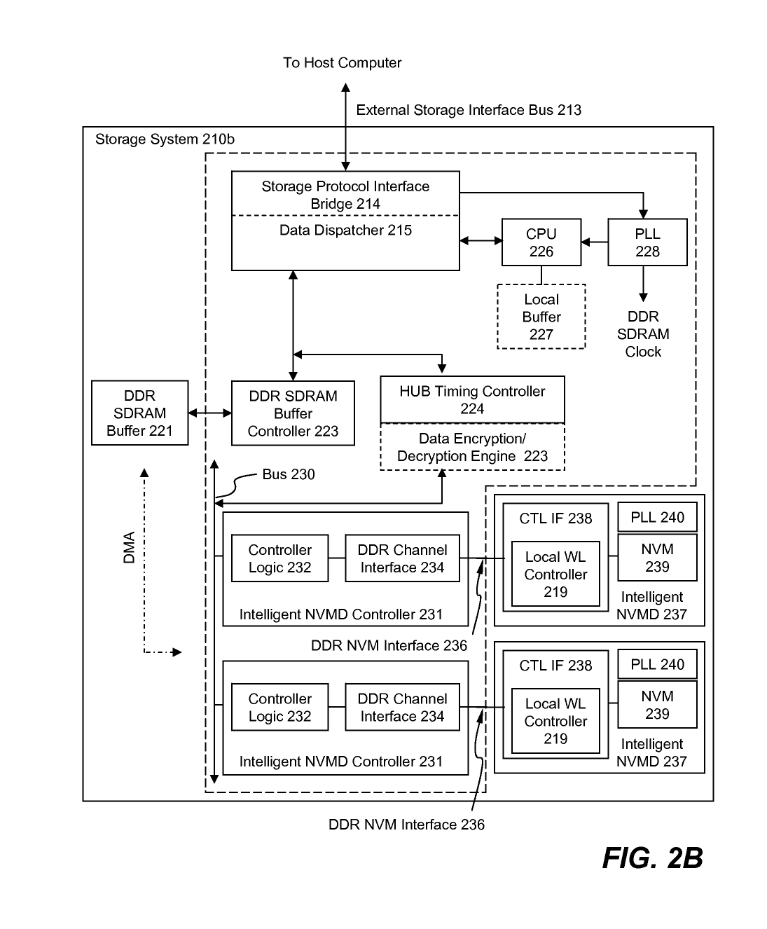

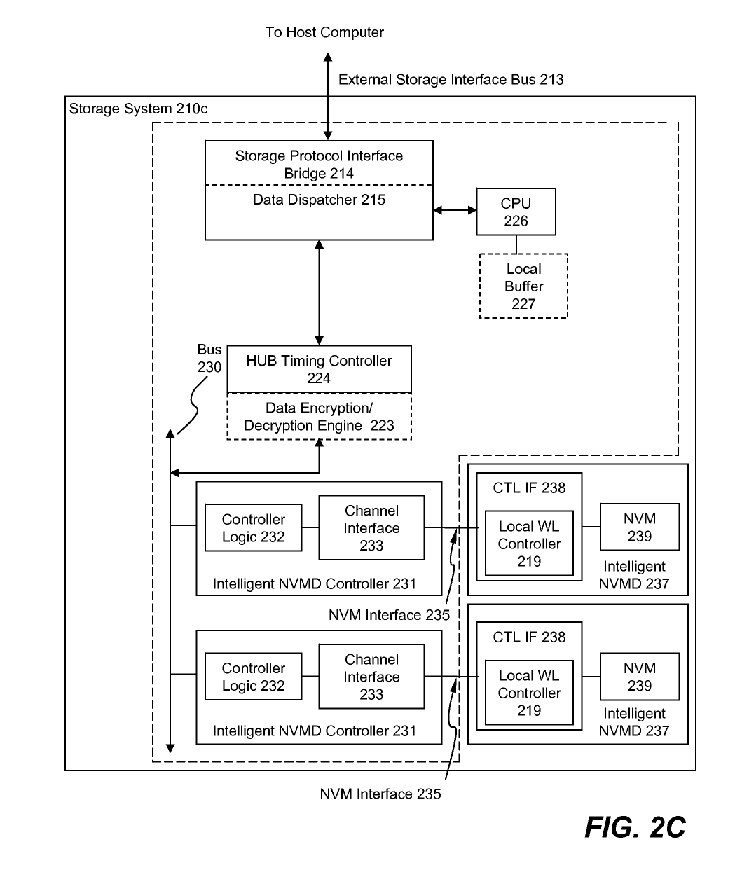

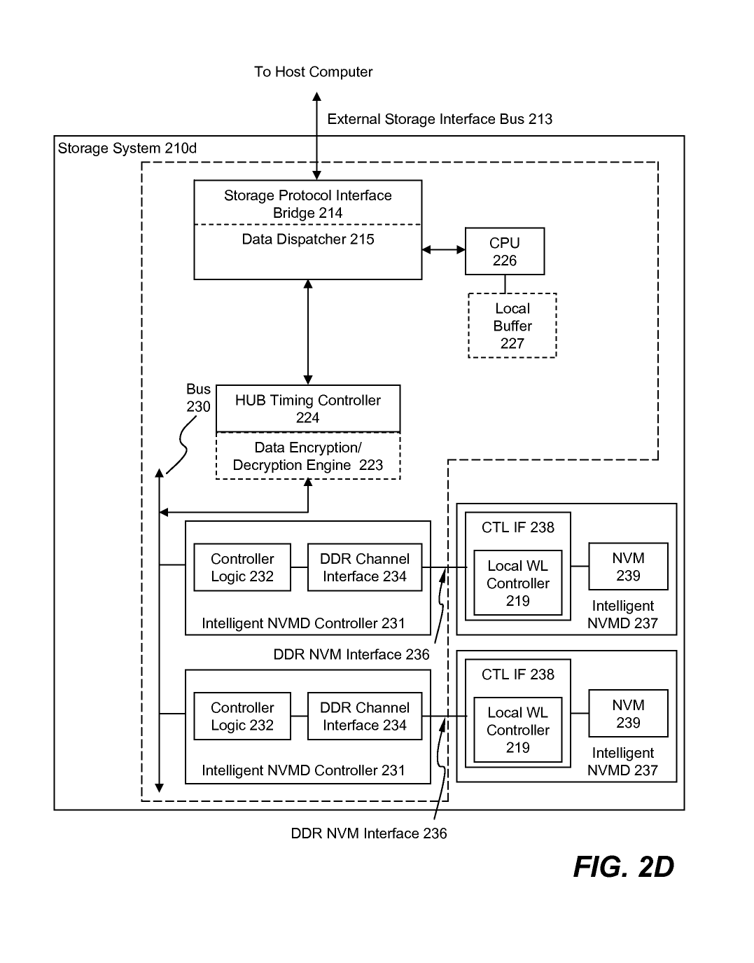

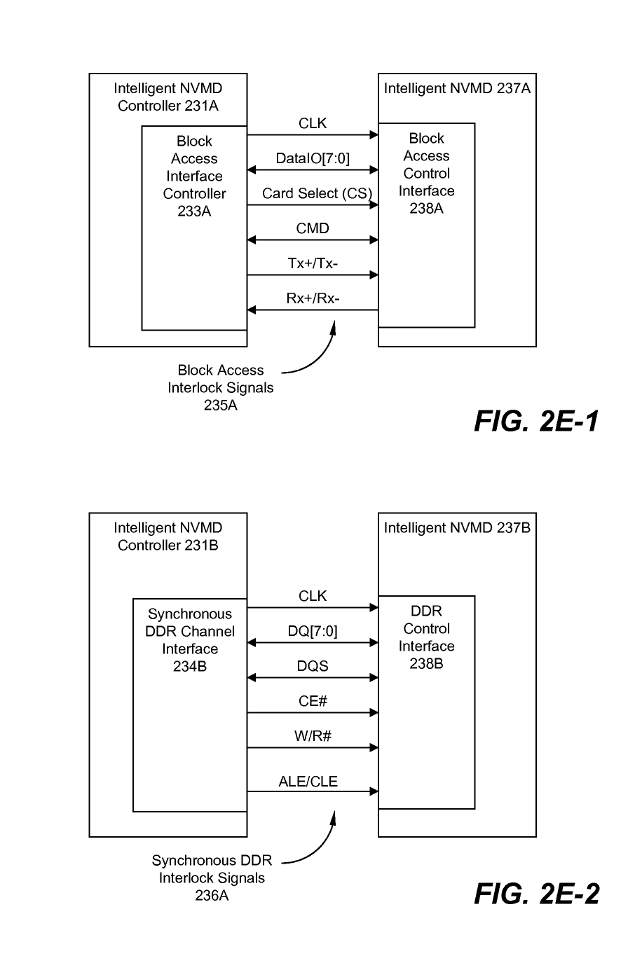

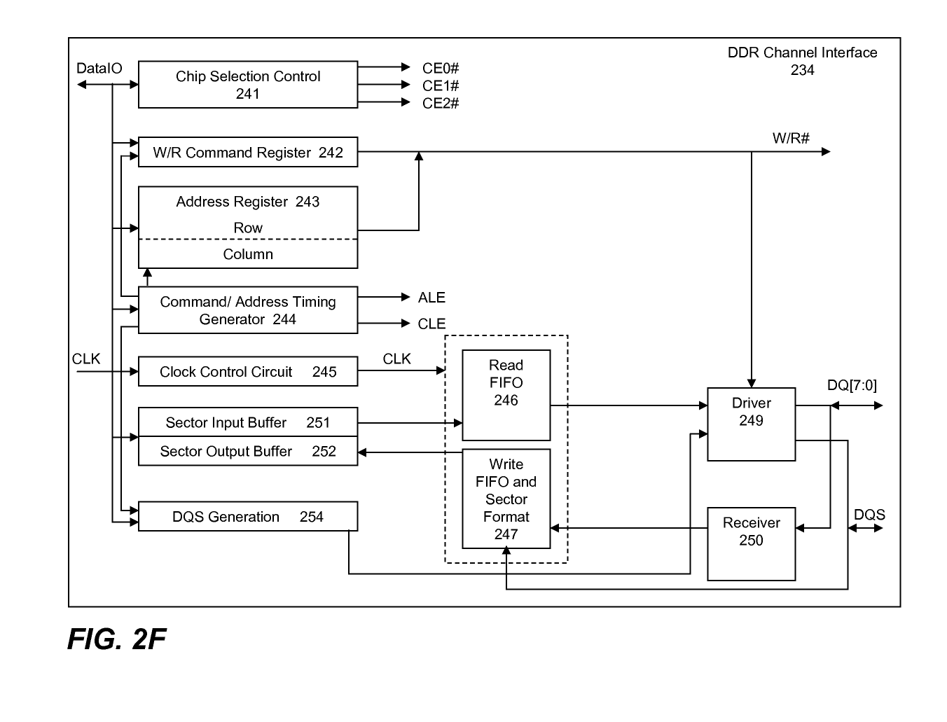

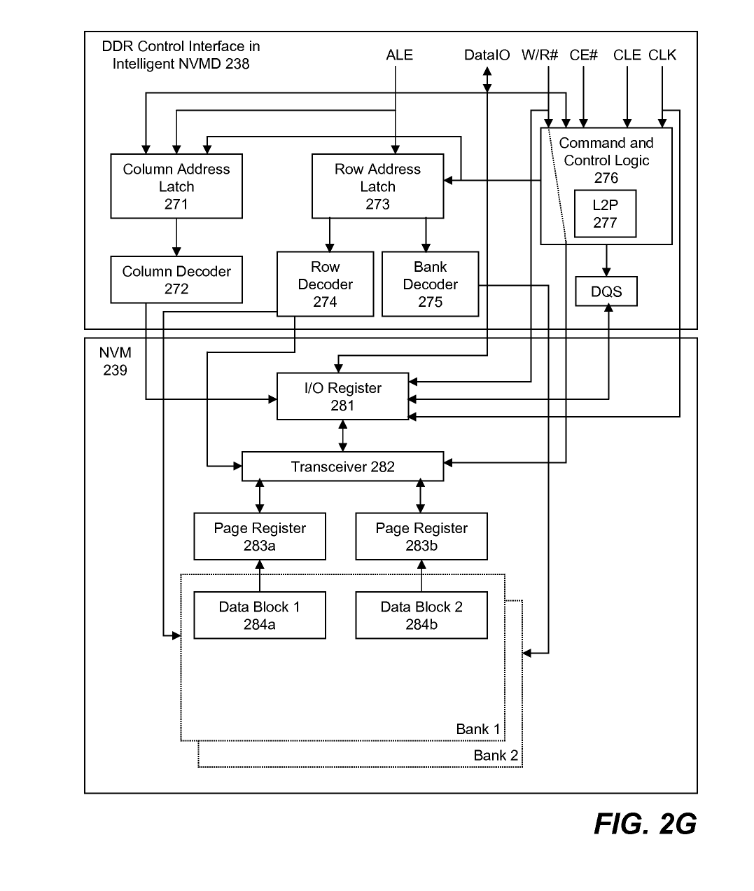

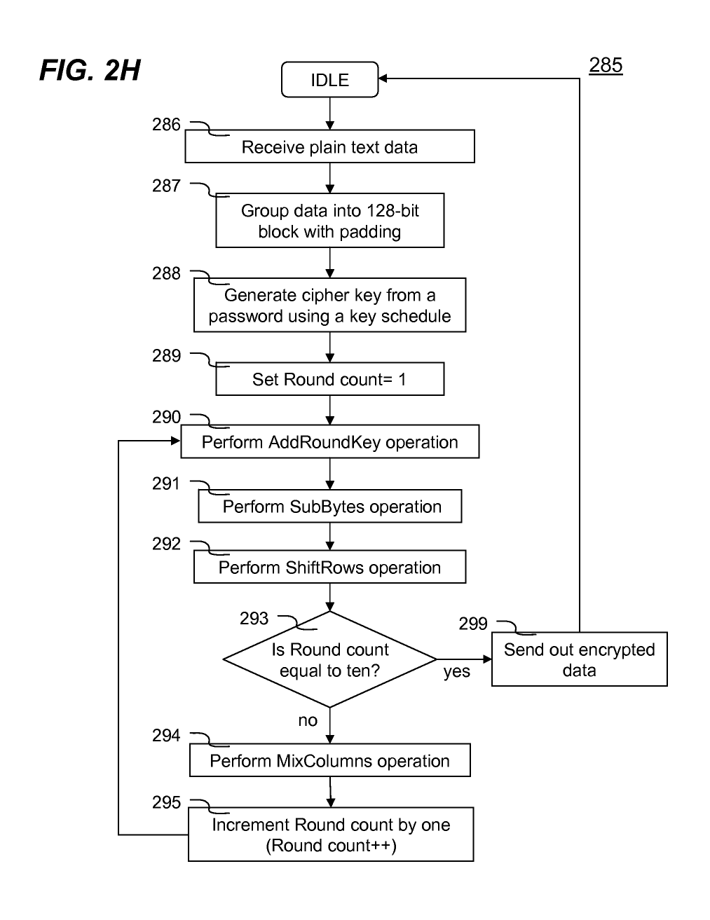

Referring now to FIG. 2A, which is a block diagram depicting a first exemplary non-volatile memory (NVM) based storage system 210a, according to an embodiment of the present invention. The first NVM based storage system 210a comprises at least one intelligent NVM device 237, an internal bus 230, at least one intelligent NVM device controller 231, a volatile memory buffer 220, a volatile memory buffer controller 222, a hub timing controller 224, a local central processing unit (CPU) 226, a phase-locked loop (PLL) circuit 228, a storage protocol interface bridge 214 and a data dispatcher 215.

Each of the at least one intelligent NVM device 237 includes a control interface (CTL IF) 238 and a NVM 239. The control interface 238 is configured for communicating with corresponding intelligent NVM device controller 231 via NVM interface 235 for logical addresses, commands, data and timing signals. The control interface 238 is also configured for extracting a logical block address (LBA) from each of the received logical addresses such that corresponding physical block address (PBA) is determined within the intelligent NVM device 237. Furthermore, the control interface 238 is configured for managing wear leveling (WL) of NVM 239 locally with a local WL controller 219. The local WL controller 219 may be implemented in software (i.e., firmware) and/or hardware. Each local WL controller 219 is configured to ensure usage of physical non-volatile memory of respective NVM device 237 is as even as possible. The local WL controller 219 operates on physical block addresses of each respective NVM device. Additionally, the control interface 238 is also configured for managing bad block (BB) relocation to make sure each of the physical NVM devices 237 will have a even wear level count to maximize usage. Moreover, the control interface 238 is also configured for handing Error Code Correction (ECC) of corrupted data bits occurred during NVM read/write operations hence further ensuring reliability of the NVMD devices 237. NVM 239 may include, but not necessarily limited to, single-level cell flash memory (SLC), multi-level cell flash memory (MLC), phase-change memory (PCM), Magnetoresistive random access memory, Ferroelectric random access memory, Nano random access memory. For PCM, local wear level controller 219 does not need to manage wear level but other functions such as ECC and bad block relocation instead.

Each of the at least one intelligent NVM controller 231 includes a controller logic 232 and a channel interface 233. Intelligent NVM controllers 231 are coupled to the internal bus 230 in parallel. The volatile memory buffer 220, also coupled to the internal bus, may comprise synchronous dynamic random access memory (SDRAM). Data transfer between the volatile memory buffer 220 and the non-volatile memory device 237 can be performed via direction memory access (DMA) via the internal bus 230 and the intelligent NVM device controller 231. Volatile memory buffer 220 is controlled by volatile memory buffer controller 222. PLL circuit 228 is configured for generating a timing signal for the volatile memory buffer 220 (e.g., a SDRAM clock). The hub timing controller 224 together with data dispatcher 215 is configured for dispatching commands and sending relevant timing signals to the at least one intelligent NVM device controller 231 to enable parallel data transfer operations. For example, parallel advanced technology attachment (PATA) signals may be sent over the internal bus 230 to different ones of the intelligent NVM device controllers 231. One NVM device controller 231 can process one of the PATA requests, while another NVM device processes another PATA request. Thus multiple intelligent NVM devices 237 are accessed in parallel.

CPU 226 is configured for controlling overall data transfer operations of the first NVM based storage system 210a. The local memory buffer 227 (e.g., static random access memory) may be configured as data and/or address buffer to enable faster CPU execution. The storage protocol interface bridge 214 is configured for sending and/or receiving commands, addresses and data from a host computer via an external storage interface bus 213 (e.g., interface bus 113 of FIG. 1A or FIG. 1B). Examples of the host computer (not shown) may be a personal computer, a server, a consumer electronic device, etc. The external storage interface bus 213 may include a Peripheral Component Interconnect Express (PCI-E) bus.

Finally, in order to increase security of data stored in the storage system 210a, stored data may be encrypted using a data encryption/decryption engine 223. In one embodiment, the data encryption/decryption engine 223 is implemented basing on Advanced Encryption Standard (AES), for example, a 128-bit AES.

FIG. 2B shows a second exemplary NVM based storage system 210b in accordance with another embodiment of the present invention. The second NVM based storage system 210b is an alternative to the first storage system 210a. Instead of a generic volatile memory buffer 220, a double data rate synchronous dynamic random access memory (DDR SDRAM) buffer 221 is used. Accordingly, a DDR SDRAM buffer controller 223 is used for controlling the DDR SDRAM buffer 221 and PLL circuit 228 to control generation DDR SDRAM clock signals in the second exemplary NVM based storage system 210b. Each of the intelligent NVM device controllers 231 contains a DDR channel interface 234. Interface 236 between the intelligent NVM device 237 and corresponding controller 231 is based on DDR-NVM. Additionally, a PLL 240 is located within the intelligent NVMD 237 to generate signals for DDR-NVM 239.

FIGS. 2C and 2D show third and fourth NVM based storage systems, respectively. The third storage system 210c is an alternative to the first storage system 210a without a volatile memory buffer 220, and associated volatile memory controller 222 and PLL circuit 228. The fourth storage system 210d is an alternative to the second storage system 210b without the DDR SDRAM buffer 221, DDR SDRAM buffer controller 223 and PLL circuit 228.

FIG. 2E-1 is a diagram showing block access interlock signals 235A between a block access interface controller 233A in an intelligent NVM device controller 231A and a block access control interface 238A in the intelligent NVM device 237A of the NVM based storage system 210a of FIG. 2A. The block access interlock signals 235A includes a main clock (CLK), 8-bit data (DQ[7:0]), a card selection signal (CS), command (CMD), and a pair of serial control signals (Tx+/Tx− and Rx+/Rx−). The serial control signals are configured to supply different voltages such that the differences of the voltages can be used for transmitting data. Transmitting signals (Tx+/Tx−) are from the intelligent NVM device controller 231A to the intelligent NVM device 237A, while receiving signals (Rx+/Rx−) are in the reverse direction from the intelligent NVM device 237B to the intelligent NVM device controller 231B.

Details of synchronous DDR interlock signals 236A are shown in FIG. 2E-2. In the exemplary NVM based storage system 210b of FIG. 2B, the intelligent NVM device controller 231B communicates with the intelligent NVM device 237B synchronous DDR interlock signals as follows: main clock signal (CLK), data (e.g., 8-bit data denoted as DQ[7:0]), data strobe signal (DQS), chip enable signal (CE#), read-write indication signal (W/R#) and address latch enable (ALE)/command latch enable (CLE) signal. Main clock signal is used as a reference for the timing of commands such as read and write operations, including address and control signals. DQS is used as a reference to latch input data into the memory and output data into an external device.

FIG. 2F is a diagram showing details of the DDR channel controller 234 in the NVM based storage system 210b of FIG. 2B. The DDR channel controller 234 comprises a chip selection control 241, a read/write command register 242, an address register 243, a command/address timing generator 244, a main clock control circuit 245, a sector input buffer 251, a sector output buffer 252, a DQS generator 254, a read first-in-first-out (FIFO) buffer 246, a write FIFO 247, a data driver 249 and a data receiver 250.

The chip selection control 241 is configured for generating chip enable signals (e.g., CE0#, CE1#, etc.), each enables a particular chip that the DDR channel controller 234 controls. For example, multiple NVM devices controlled by the DDR channel controller 234 include a plurality of NVM chips or integrated circuits. The DDR channel controller 234 activates a particular one of them at any one time. The read/write command register 242 is configured for generating read or write signal to control either a read or write data transfer operation. The address register 243 comprises a row and column address. The command/address timing generator 244 is configured for generating address latch enable (ALE) and command latch enable (CLE) signals. The clock control circuit 245 is configured to generating a main clock signal (CLK) for the entire DDR channel controller 234. The sector input buffer 251 and the sector output buffer 252 are configured to hold data to be transmitted in and out of the DDR channel controller 234. DQS generator 254 is configured to generating timing signals such that data input and output are latched at a different faster data rate than the main clock cycles. The read FIFO 246 and write FIFO 247 are buffers configured in conjunction with the sector input/output buffer. The driver 249 and the receiver 250 are configured to send and to receive data, respectively.

FIG. 2G is a diagram showing the DDR control interface 238 and NVM 239 in the NVM based storage system 210b of FIG. 2B. The DDR control interface 238 receives signals such as CLK, ALE, CLE, CE#, W/R#, DQS and data (e.g., DataIO or DQ[7:0]) in a command and control logic 276. Logical addresses received are mapped to physical addresses of the NVM 239 in the command and control logic 276 based on a mapping table (L2P) 277. The physical address comprises a column and row addresses that are separately processed by a column address latch 271 and a row address latch 273. Column address is decoded in a column address decoder 272. Row address includes two portions that are decoded by a bank decoder 275 and a row decoder 274. The decoded addresses are then sent to input/output register 281 and transceiver 282 of the NVM 239. Actual data are saved into page registers 283a-b before being moved into appropriate data blocks 284a-b of selected banks or planes (e.g., Bank 1, 2, etc.).

Referring now to FIG. 2H, which is a flowchart illustrating an exemplary process 285 of encrypting plain text data using an data encryption/decryption engine 223 based on 128-bit Advanced Encryption Standard (AES) in accordance with one embodiment of the present invention. Process 285 may be implemented in software, hardware or a combination of both.

Process 285 starts at an ‘IDLE’ state until the data encryption/decryption engine 223 receives plain text data (i.e., unencrypted data) at step 286. Next, at step 287, process 285 groups received data into 128-bit blocks (i.e., states) with each block containing sixteen bytes or sixteen (16) 8-bit data arranged in a 4×4 matrix (i.e., 4 rows and 4 columns of 8-bit data). Data padding is used for ensuring a full 128-bit data. At step 288, a cipher key is generated from a password (e.g., user entered password).

At step 289, a counter (i.e., Round count) is set to one. At step 289, process 285 performs an ‘AddRoundKey’ operation, in which each byte of the state is combined with the round key. Each round key is is derived from the cipher key using the key schedule (e.g., Rjindael's key schedule). Next, at step 291, process 285 performs a ‘SubBytes’ operation (i.e., a non-linear substitution step), in which each byte is replaced with another according to a lookup table (i.e., the Rijndael S-box). The S-box is derived from the multiplicative inverse over Galois Field GF(2⁸). To avoid attacks based on simple algebraic properties, the S-box is constructed by combining the inverse function with an invertible affine transformation. The S-box is also chosen to avoid any fixed point (and so is a derangement), and also any opposite fixed points.

At step 292, next operation performed by process 285 is called ‘ShiftRows’. This is a transposition step where each row of the state is shifted cyclically a certain number of steps. For AES, the first row is left unchanged. Each byte of the second row is shifted one to the left. Similarly, the third and fourth rows are shifted by offsets of two and three respectively. For the block of size 128 bits and 192 bits the shifting pattern is the same. In this way, each column of the output state of the ShiftRows step is composed of bytes from each column of the input state. (Rijndael variants with a larger block size have slightly different offsets). In the case of the 256-bit block, the first row is unchanged and the shifting for second, third and fourth row is 1 byte, 2 bytes and 3 bytes respectively—although this change only applies for the Rijndael cipher when used with a 256-bit block, which is not used for AES.

Process 285 then moves to decision 293, it is determined if the counter has reached ten (10). If ‘no’, process 285 performs ‘MixColumns’ operation at step 294. This step is a mixing operation which operates on the columns of the state, combining the four bytes in each column. The four bytes of each column of the state are combined using an invertible linear transformation. The MixColumns function takes four bytes as input and outputs four bytes, where each input byte affects all four output bytes. Together with ShiftRows, MixColumns provides diffusion in the cipher. Each column is treated as a polynomial over GF(2⁸) and is then multiplied modulo x⁴+1 with a fixed polynomial c(x)=3x³+x²+x+2. The MixColumns step can also be viewed as a multiplication by a particular maximum distance separable (MDS) matrix in Rijndael's finite field. The counter is then incremented by one (1) at step 295 before moving back to step 290 for another round.

When the counter ‘Round count’ is determined to be 10 at decision 293, process 285 sends out the encrypted data (i.e., cipher text) before going back to the ‘IDLE’ state for more data. It is possible to speed up execution of the process 285 by combining ‘SubBytes’ and ‘ShiftRows’ with ‘MixColumns’, and transforming them into a sequence of table lookups.

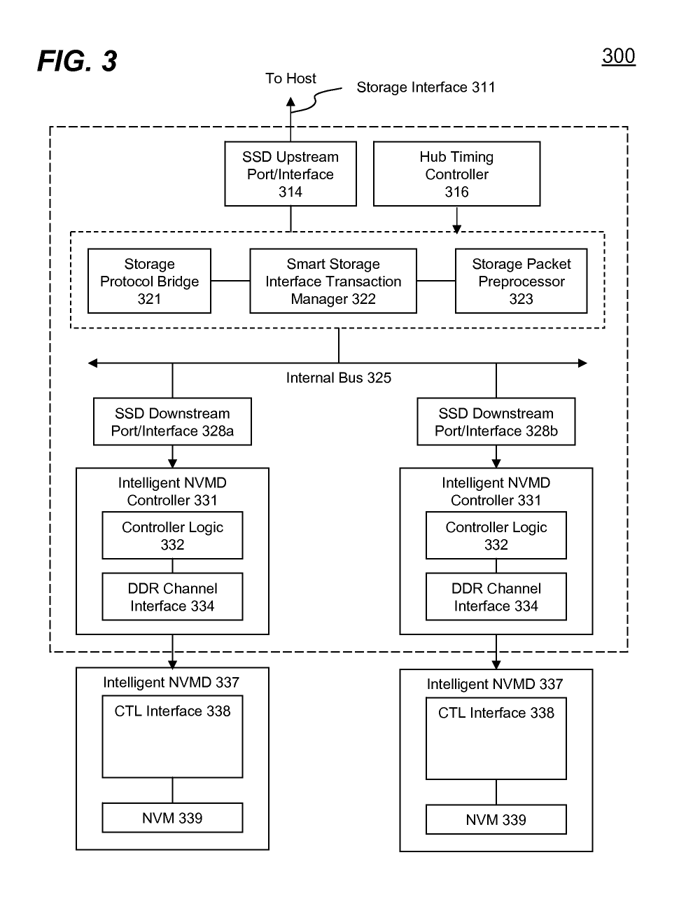

FIG. 3 is a block diagram illustrating salient components of an exemplary dual-mode NVM based storage device. The dual-mode NVM based storage device 300 connects to a host via a storage interface 311 (e.g., Universal Serial Bus (USB) interface) through upstream interface 314. The storage system 300 connects to intelligent NVM devices 337 through SSD downstream interfaces 328 and intelligent NVM device controller 331. The interfaces provide physical signaling, such as driving and receiving differential signals on differential data lines of storage interfaces, detecting or generating packet start or stop patterns, checking or generating checksums, and higher-level functions such as inserting or extracting device addresses and packet types and commands.

Hub timing controller 316 activates the storage system 300. Data is buffered across storage protocol bridge 321 from the host to NVM devices 337. Internal bus 325 allows data to flow among storage protocol bridge 321 and SSD downstream interfaces 328. The host and the endpoint may operate at the same speed (e.g., USB low speed (LS), full speed (FS), or high-speed (HS)), or at different speeds. Buffers in storage protocol bridge 321 can store the data. Storage packet preprocessor 323 is configured to process the received data packets.

When operating in single-endpoint mode, transaction manager 322 not only buffers data using storage protocol bridge 321, but can also re-order packets for transactions from the host. A transaction may have several packets, such as an initial token packet to start a memory read, a data packet from the memory device back to the host, and a handshake packet to end the transaction. Rather than have all packets for a first transaction complete before the next transaction begins, packets for the next transaction can be re-ordered by the storage system 300 and sent to the memory devices before completion of the first transaction. This allows more time for memory access to occur for the next transaction. Transactions are thus overlapped by re-ordering packets.

Transaction manager 322 may overlap and interleave transactions to different flash storage blocks, allowing for improved data throughput. For example, packets for several incoming transactions from the host are stored in storage protocol bridge 321 or associated buffer (not shown). Transaction manager 322 examines these buffered transactions and packets and re-orders the packets before sending them over internal bus 325 to the NVM devices 337.

A packet to begin a memory read of a flash block through a first downstream interface 328a may be reordered ahead of a packet ending a read of another flash block through a second downstream interface 328b to allow access to begin earlier for the second flash block.

FIG. 4A is a diagram showing a first exemplary intelligent non-volatile memory (NVM) device controller for single channel intelligent NVMD array in accordance with one embodiment of the present invention. The first NVM device controller comprises a processor 412 that controls two NVM controller interfaces: odd interface 416a and even interface 416b, and a clock source 417. Each of the two NVM controller interfaces sends separate card selection signal (e.g., CS#1, CS#2) and logical address (e.g., LBA) to respective intelligent NVM device 424a-b under control. Clock source 417 is configured to send out a single timing signal (e.g., CLK_SYNC) in a single channel to all of the intelligent NVM devices 424a-b. Each of the intelligent NVM devices 424a-b contains a control interface 426 and a NVM 428 (part of the NVM array).

FIG. 4B is a diagram showing a second exemplary intelligent non-volatile memory (NVM) device controller for multiple channel interleaved intelligent NVMD array in accordance with one embodiment of the present invention. The second intelligent NVM device controller comprises a processor 432 that controls two NVM controller interfaces (odd 436a and even 436b) and two separate clock sources (odd 438a and even 438b). Each of the NVM controller interfaces 436 controls at least two intelligent NVM devices 424, for example, odd NVM controller interface 436a controls intelligent NVM devices #1 424a and #3 424c using a timing signal (CLK_SYNC_ODD) from the odd clock source 438a. Because there are at least two NVM devices 424 controlled by each of the NVM controller interfaces 436, data transfer operations to the at least two NVM device can be performed with an interleaved addressing scheme with higher efficiency thereby achieving high performance.

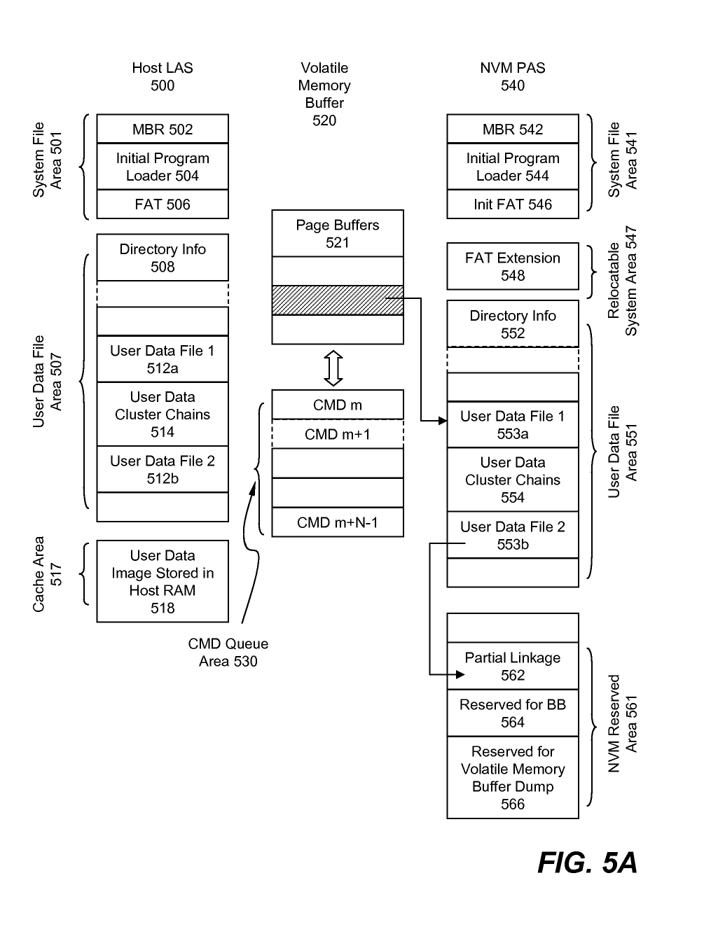

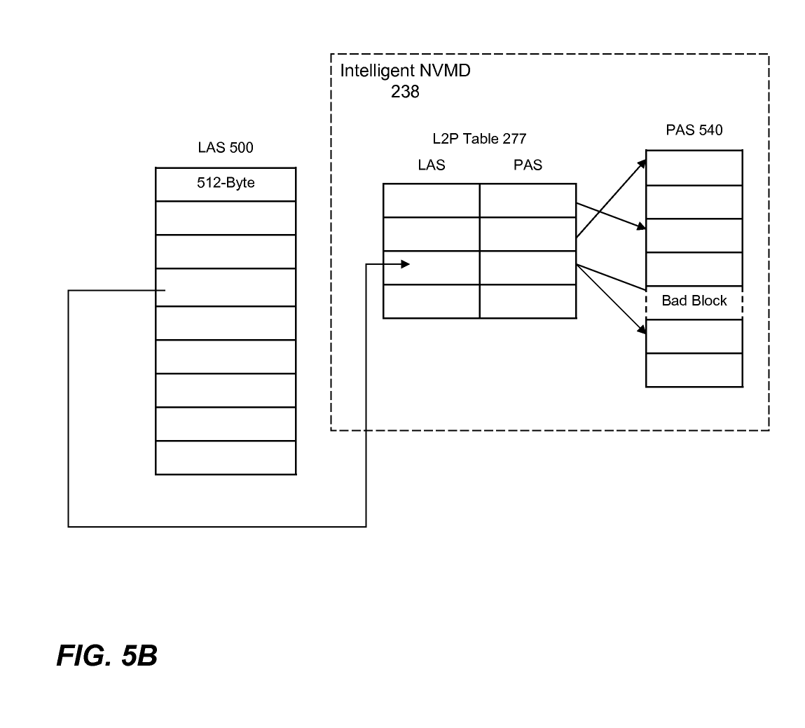

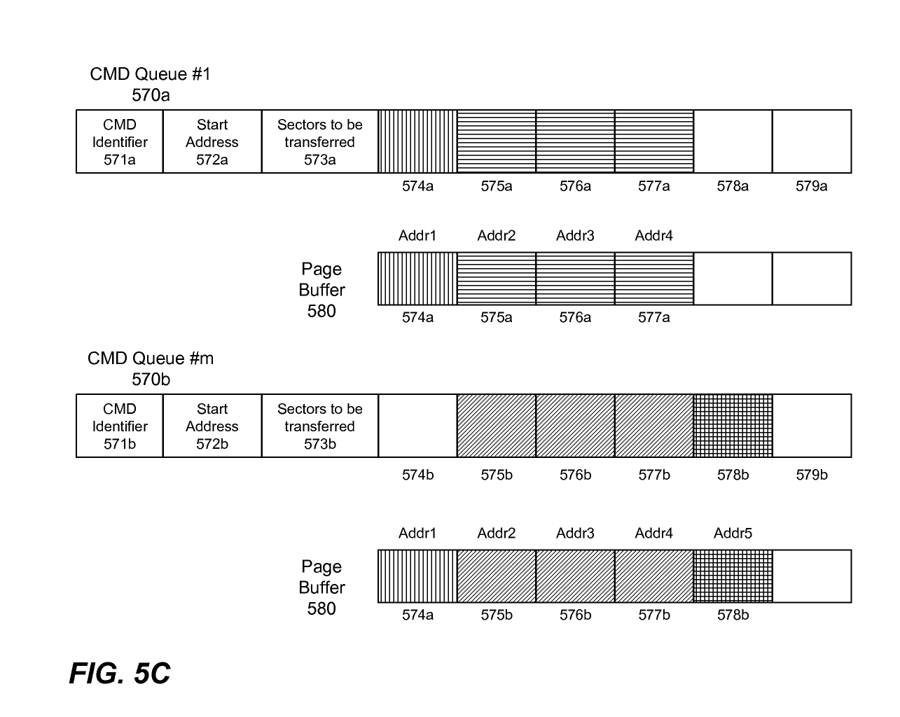

Logical address space (LAS) 500 in a host computer is shown in the left column of FIG. 5A. LAS 500 is partitioned into three areas: system file area 501, user data file area 507 and cache area 517. Examples of files in the system file area 501 are master boot record (MBR) 502, initial program loader 504 and file allocation table (FAT) 506. In the user data file area 507, directory information 508, user data files 512a-b and user data file cluster chain 514 are exemplary files. Finally user data image stored in a cache memory 518 is used for improving system performance.

Physical address space (PAS) 540 in a non-volatile memory device is shown in the right column of FIG. 5A. PAS 540 is partitioned into four areas: system file area 541, relocatable system file area 547, user data file area 551 and reserved area 561. The system file area 541 contains files such as MBR 542, initial program loader 544 and initial FAT 546. The relocatable system file area 547 may contain FAT extension 548. The user data file area 551 includes directory information 552, user data files 553a-b, and user data cluster chains 554. The reserved area 561 may include partial data file linkage 562, reserved area for bad block (BB) 564 and a reserved area for storing volatile memory buffer 566 in an emergency. The reserved area for storing volatile memory buffer 566 is configured for holding data from the volatile memory buffer when unexpected power failure occurs, for example, last block of the non-volatile memory device may be designated. In one embodiment, the last block has an address of ‘0xFFFF0000’.

Volatile memory buffer 520 is partitioned into two portions: page buffers 521 and command (CMD) queue 530. The page buffers 521 are configured for holding data to be transmitted between the host and the NVM device, while the command queue 530 is configured to store received commands from the host computer. The size of a page buffer is configured to match page size of physical NVM, for example, 2,048-byte for MLC flash. In addition, each page would require additional bytes for error correction code (ECC). The command area 530 is configured to hold N commands, where N is a whole number (e.g., positive integer). The command queue 530 is so sized that stored commands and associated data can be flushed or dumped to the reserved area 566 using reserved electric energy stored in a designated capacitor of the NVM based storage system. In a normal data transfer operation, data stored into NVM device must be mapped from LAS 500 to PAS 540. However, in an emergency situation, such as upon detecting an unexpected power failure, data transfer (i.e., flushing or dumping data from volatile memory buffer to reserved area) is performed without any address mapping or translation. Goal is to capture perishable data from volatile memory into non-volatile memory so that data can be later recovered.

FIG. 5B shows details of L2P table 277 configured for mapping LAS 500 to PAS 540 inside the intelligent NVM device (NVMD) 238. The LAS to PAS mapping is a one-to-one relationship. When a bad block (BB) is encountered, a new block must be allocated before any data transfer can be performed to the NVMD 238.

One advantage of using volatile memory buffer is to allow data write commands with overlapped target addresses to be merged before writing to the NVMD. Merging write commands can eliminate repeated data programming to same area of the NVM thereby increasing endurance of the NVMD. FIG. 5C is an example demonstrating how to merge data write commands in volatile memory buffer. There are two commands, ‘command queue #1’ 570a and ‘command queue #m’ 570b, stored in the command queue of the volatile memory buffer. Each of the command queues 570 comprises following fields: command identifier 571a, start address 572a, number of sectors to be transferred 573a and physical data for the number of sectors 574a-579a.

Shown in FIG. 5C, ‘command queue #1’ 570a contains four data sectors to be transferred starting from address ‘addr1’ 574a. As a result, page buffer 580 contains data at ‘addr1’ 574a, ‘addr2’ 575a, ‘addr3’ 576a and ‘addr4’ 577a from ‘command queue #1’ 570a. ‘command queue #m’ 570b also contains four data sectors to be transferred, but starting from address ‘addr2’ 575b.

Shown in the bottom row of FIG. 5C, page buffer 580 contains data at the following five data sectors at ‘addr1’ 574a, ‘addr2’ 575b, ‘addr3’ 576b, ‘addr4’ 577b and ‘add5’ 578b as a result of merged data from these two commands. These means that the merging of these two write commands in volatile memory eliminate programming the NVM device for those overlapped area.

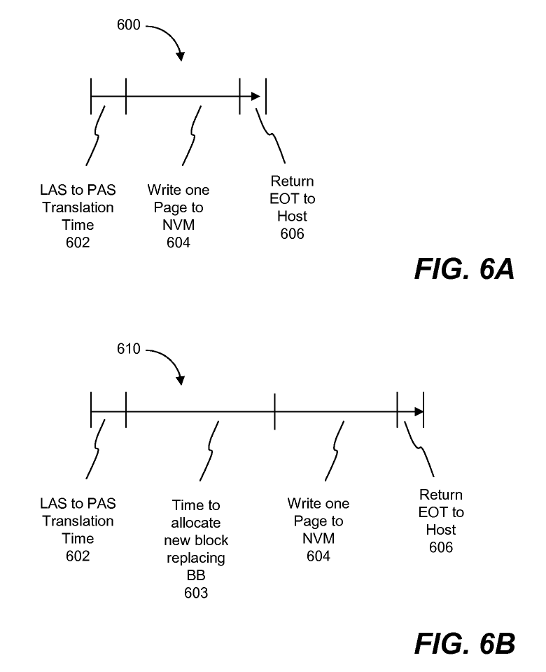

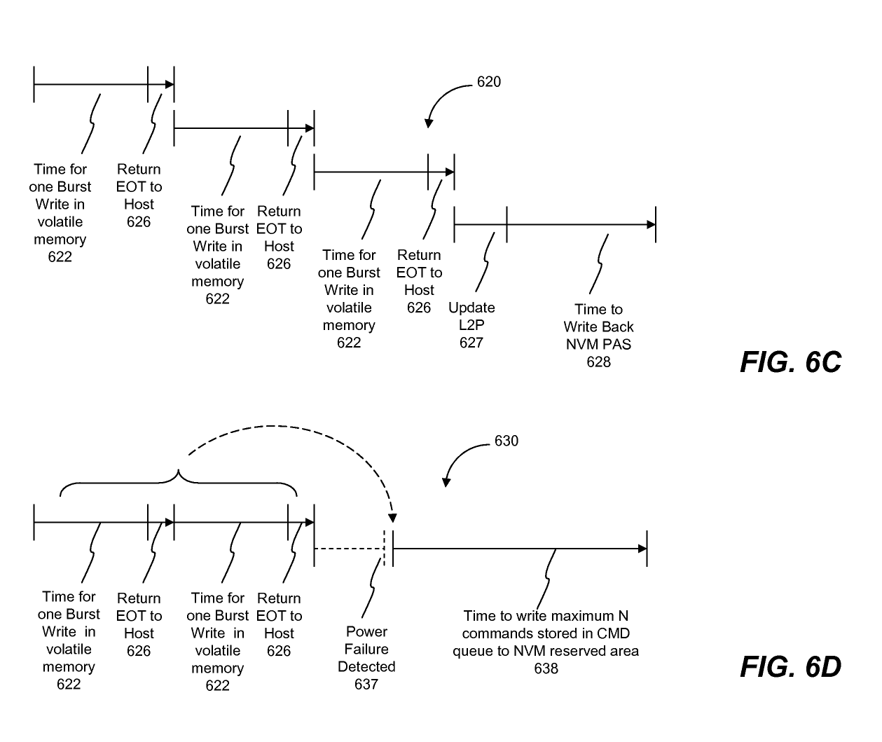

FIG. 6A is a first timeline 600 showing time required to perform a normal data programming operation of one data page to the NVM device without volatile memory buffer support. The timeline 600 contains three portions: 1) LAS to PAS translation time 602; 2) writing one data page to the NVM device 604; and 3) time to notify the host with an ‘end-of-transfer’ (EOT) signal 606. The ‘EOT’ is used for notifying the host that the data transfer operation has been completed.

FIG. 6B is a second timeline 610, which is similar to the first timeline of FIG. 6A. The difference is that a bad block is encountered during data transfer. The second timeline 610 contains four parts: 1) LAS to PAS translation time 602; 2) allocating a new data block to replace the bad block encountered 603; 3) writing one data page to the NVM device 604; and 4) time to notify the host with an ‘end-of-transfer’ (EOT) signal 606.

FIG. 6C is a third timeline 620 showing normal data transfer operation in a NVM based storage system with a volatile memory buffer support. The third timeline 620 contains a number of burst writes (e.g., three writes) in the volatile memory buffer and time to write back those data to the NVM device. Each of the burst writes contains two parts: 1) time for one burst write cycle in the volatile memory 622; and 2) time to notify the host with an ‘end-of-transfer’ (EOT) signal 626. When page buffers or command queue are full, the data needs to be written or programmed to the NVM device. The write back time includes two portions: 1) time for mapping LAS to PAS and updating L2P table 627 and 2) time for actually programming the NVM device 628.

FIG. 6D is a fourth timeline 630 showing emergency data transfer operation in a NVM based storage system upon detecting an unexpected power failure. In the fourth timeline 630, the third burst write cycle is interrupted by an unexpected power failure 637. Upon detecting such power failure, up to maximum N commands and associated data stored in the command queue of the volatile memory buffer are dumped or flushed to reserved area of the NVM device right away (shown in 638). Due to the nature of urgency and due to the limited reserved electric energy stored in a capacitor, no address mapping is performed. The data are copied to the reserved area of the NVM device without any modification. Upon restart of the storage system, stored data in the reserved area is used for restoring the volatile memory buffer before resuming normal operation of the storage system.

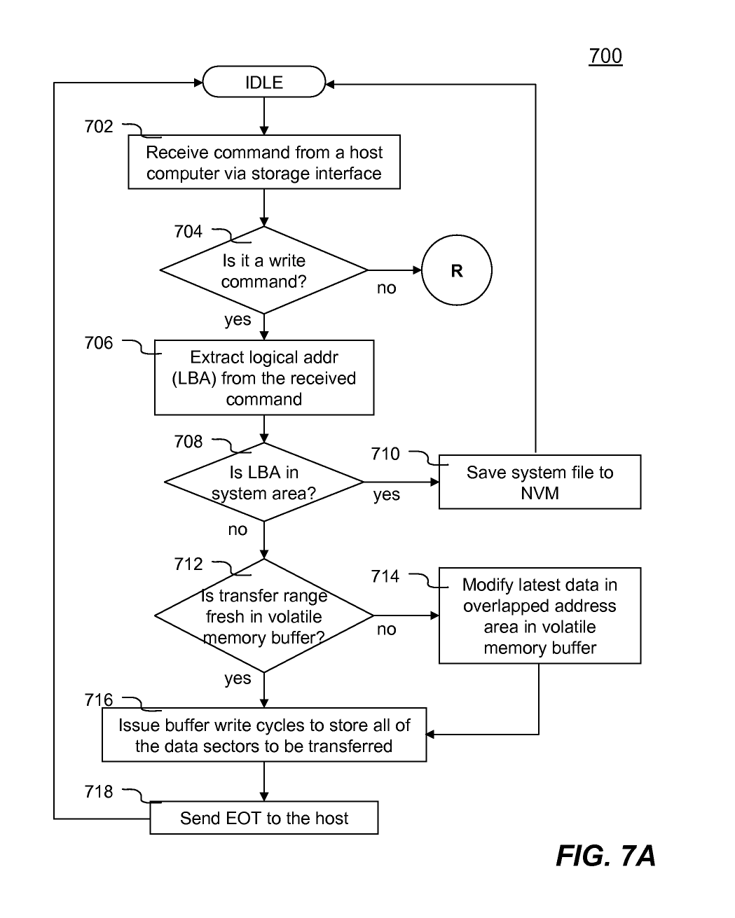

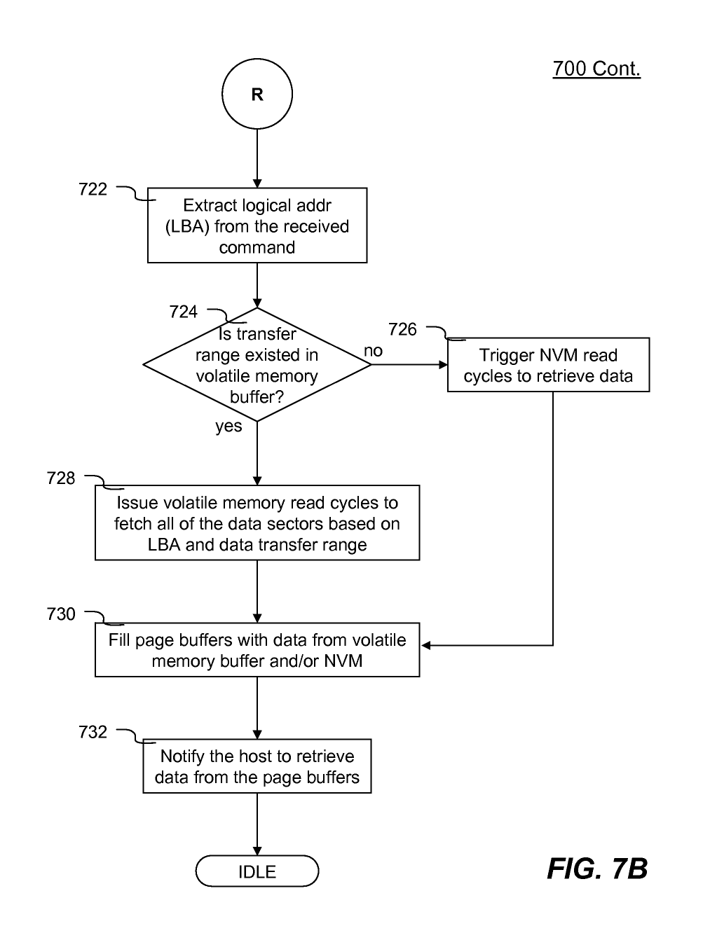

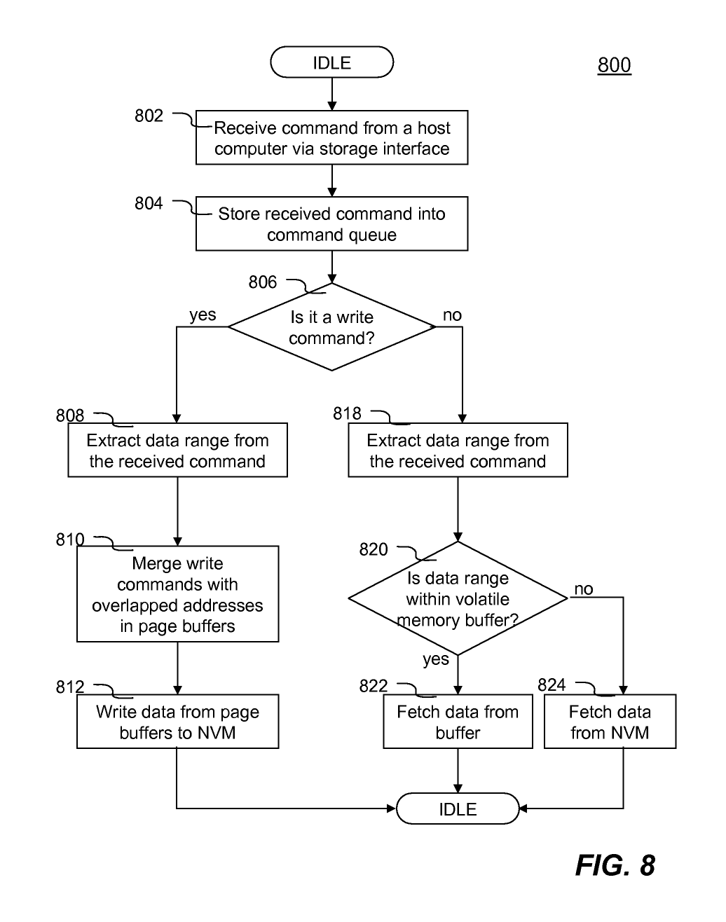

Referring now to FIGS. 7A-7B, which are collectively a flowchart illustrating an exemplary process 700 of a data transfer operation of a NVM based storage system 210b of FIG. 2B in accordance with one embodiment of the present invention. The process 700 may be implemented in software, hardware or a combination of both.

Starting at an ‘IDLE’ state until the NVM based storage system 210b has received data transfer command from a host computer via a storage interface at step 702. Next, at decision 704, it is determined whether the received command is a data write command, if ‘yes’, the storage system 210b extracts logical address (e.g., LBA) from the received command at step 706. Then, process 700 moves to decision 708, it is determined whether the logical address is located in the system area. If ‘yes’, system files (e.g., MBR, FAT, Initial program loader, etc.) are saved to the NVM device right away at step 710 and process 700 goes back to the ‘IDLE’ state for another command.

If ‘no’, process 700 moves to decision 712. It is determined whether data transfer range in the received command is fresh or new in the volatile memory buffer. If ‘no’, existing data at overlapped addresses in the page buffers is overwritten with the new data at step 714. Otherwise, data is written into appropriate empty page buffers at step 716. After the data write command has been stored in the command queue with data stored in the page buffers, an ‘end-of-transfer’ signal is sent back to the host computer at 718. Process 700 moves back to the ‘IDLE’ state thereafter.

Referring back to decision 704, if ‘no’, process 700 moves to step 722 by extracting logical address from the received data read command. Next, at decision 724, it is determined whether data transfer range exists in the volatile memory buffer. If ‘no’, process 700 triggers NVM read cycles to retrieve requested data from NVM device at step 726. Otherwise, requested data can be fetched directly from the volatile memory buffer without accessing the NVM device at step 728. Next, at step 730, requested data are filled into the page buffers before notifying the host computer at step 730. Finally, process 700 moves back to the ‘IDLE’ state for another data transfer command. It is noted that the data transfer range is determined by the start address and the number of data sectors to be transferred in each command.

FIG. 8 is a flowchart showing an exemplary process 800 of using a volatile memory buffer in the NVM based storage system 210b of FIG. 2B, according to an embodiment of the present invention. Process 800 starts in an ‘IDLE’ state until a data transfer command has been received in the NVM based storage system 210b at step 802. Next, at step 804, the received command is stored in the command queue of the volatile memory buffer. Process 800 then moves to decision 806 to determine whether the received command is a data write command. If ‘yes’, at step 808, data transfer range is extracted from the received command. Next, at step 810, command with overlapped target addresses is merged in the page buffers. Finally, data is written to the NVM device from the page buffers at step 812.

Referring back to decision 806, if ‘no’, data range is extracted from received command at step 818. Next, process 800 moves to decision 820 to determine whether the data range exists in the volatile memory buffer. If ‘no’, the process 800 fetches requested data from the NVM device at step 824, otherwise the data is fetched from the volatile memory buffer at step 822. Process 800 ends thereafter.

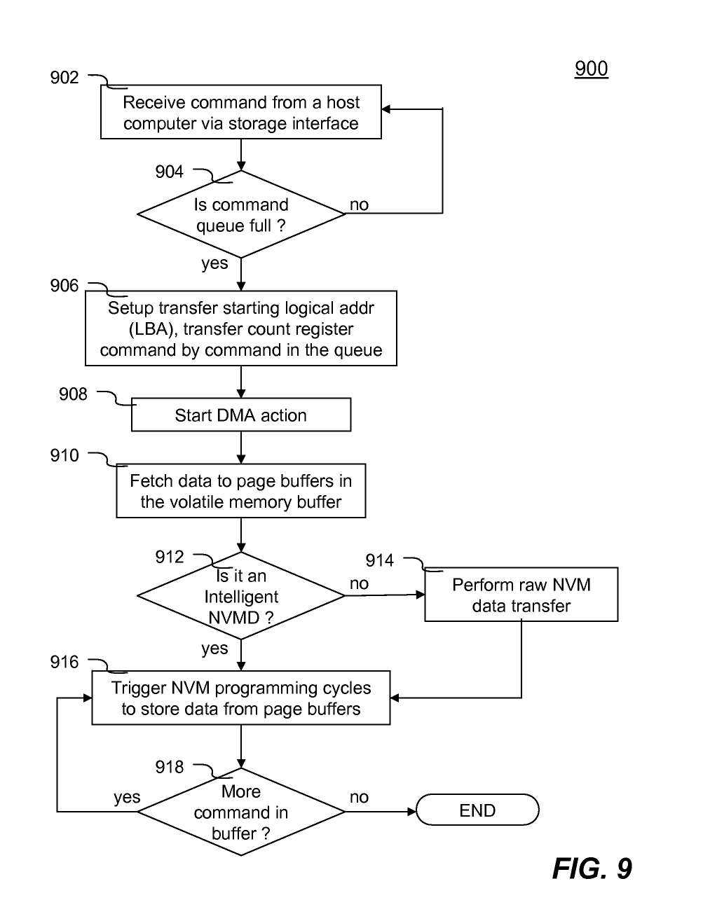

FIG. 9 is a flowchart illustrating an exemplary process 900 of performing direct memory access (DMA) operation in the NVM based storage system 210b of FIG. 2B, according to an embodiment of the present invention. Process 900 receives data transfer command from a host computer and stores into the command queue at step 902. This continues until the command queue is full, which is determined in decision 904. Next, at step 906, data transfer range is setup by extracting starting address and number of data sectors to be transferred in the received command. At step 908, the storage system 210b starts DMA action. The storage system 210b fetches data to page buffers at step 910. Process 900 moves to decision 912, it is determined whether the NVM device is an intelligent NVM device that can handle LAS to PAS mapping. If ‘no’, process 900 performs raw NVM data transfer at step 914. Otherwise, process 900 triggers NVM programming cycles to store data from the page buffers at step 916. Finally, process 900 moves to decision 918 to determine whether there are more commands in the command queue. If ‘yes’ process 900 goes back to step 916, otherwise DMA and process 900 ends.

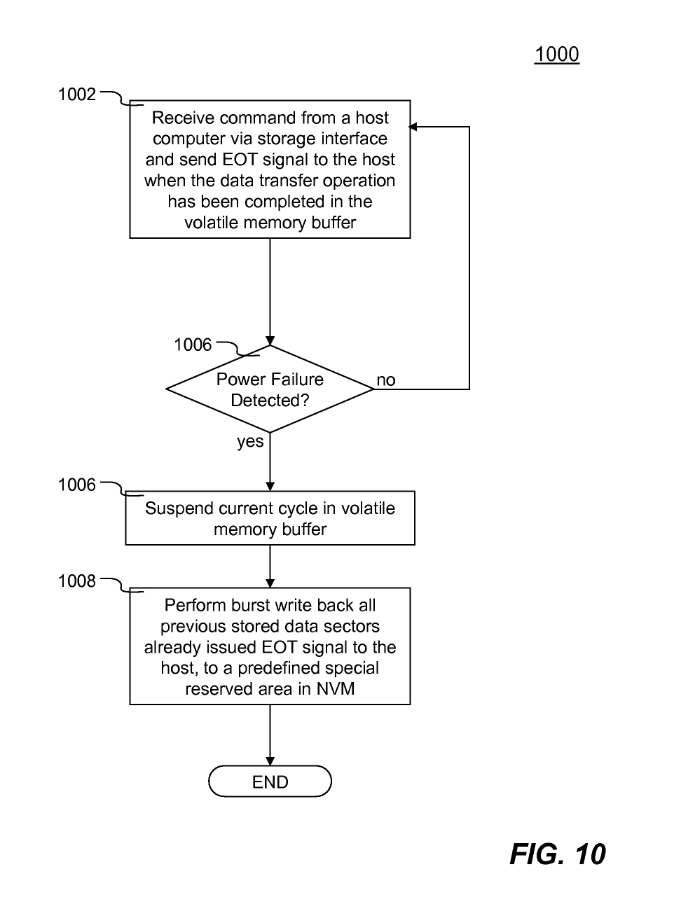

FIG. 10 a flowchart illustrating a first exemplary process 1000 after unexpected power failure has been detected in the NVM based storage system 210b of FIG. 2B, according to an embodiment of the present invention. Process 1000 starts by performing data transfer commands received from a host computer at step 1002. An ‘EOT’ signal is sent back to the host computer when the data write operation has completed in the volatile memory buffer. In the meantime, the storage system 210b monitors unexpected power failure at decision 1006. If ‘no’, process 1000 goes on in normal operation. Otherwise, at step 1008, process 1000 suspends or aborts current on-going data write operation without sending ‘EOT’ signal. Then, process 1000 starts an emergency power-down procedure by performing burst write back all of the previous stored data sectors in the page buffers already issued ‘EOT’ signal to the host computer, to the reserved area of the NVM device at step 1008. Process 1000 ends thereafter.

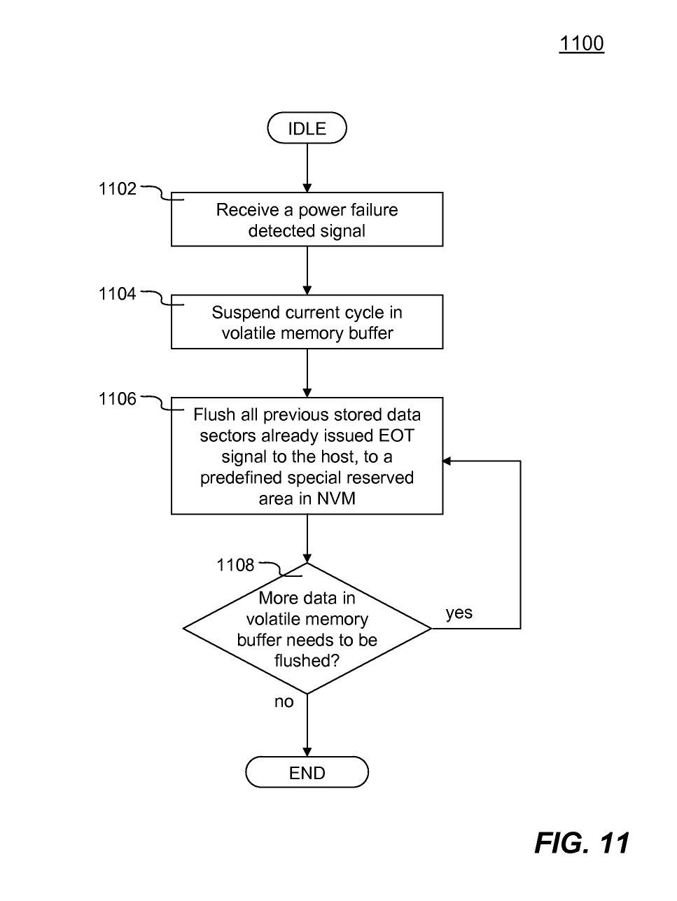

FIG. 11 is a flowchart illustrating a second exemplary process 1100 after detecting a power failure in the NVM based storage system 210b of FIG. 2B, according to an embodiment of the present invention. Process 1100 starts at an ‘IDLE’ state until the storage system has detected and received a power failure signal at step 1102. Next, at step 1104, process 1100 suspends or aborts current cycle in the volatile memory buffer. Then, at step 1106, process 1100 dumps or flushes all stored data that have issued ‘EOT’ signal to the reserved area of the NVM device one data page at a time. Decision 1108 determines whether additional data needs to be flushed. If ‘yes’, process 1100 goes back to step 1106 until no more data and process 1100 ends thereafter.

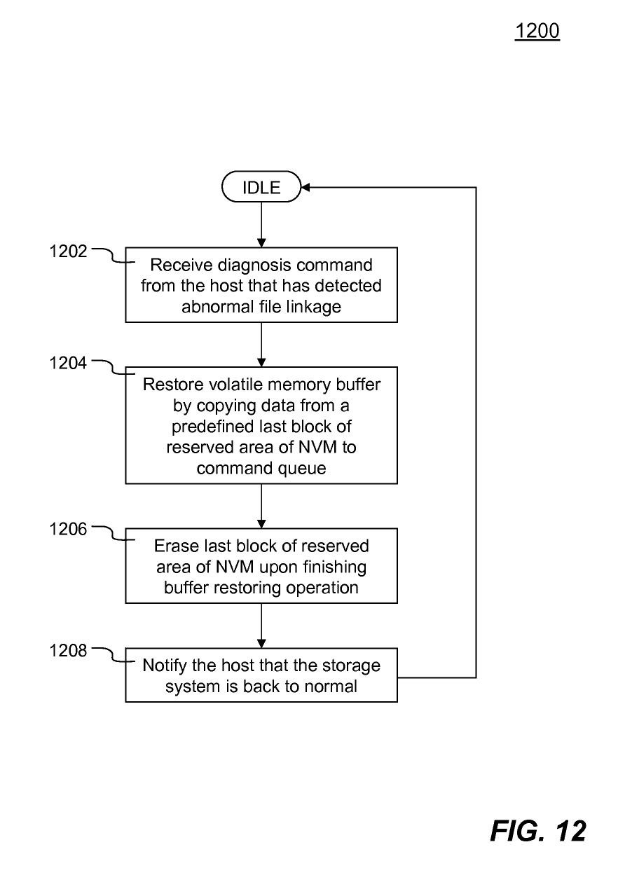

FIG. 12 is a flowchart illustrating an exemplary process 1200 of recovering of the NVM based storage system 210b of FIG. 2B after unexpected power failure, according to an embodiment of the present invention. Process 1200 starts at an ‘IDLE’ state until the storage system 210b receives a diagnosis command indicating abnormal file linkage upon power-on of the storage system 210b from a host computer at step 1202. Next, at step 1204, process 1200 restores the volatile memory buffer by copying data stored in the reserved area (e.g., last data block) of the NVM device to the volatile memory buffer. Upon successful restoration of the volatile memory buffer, process 1200 erases the stored data in the reserved area of the NVM device at step 1206. This is to ensure that the reserved area is ready for next emergency data transfer operation. Finally, at step 1208, process 1200 notifies the host computer that the NVM based storage system 210b is ready to operate in normal condition. Process 1200 moves back to the ‘IDLE’ state thereafter.

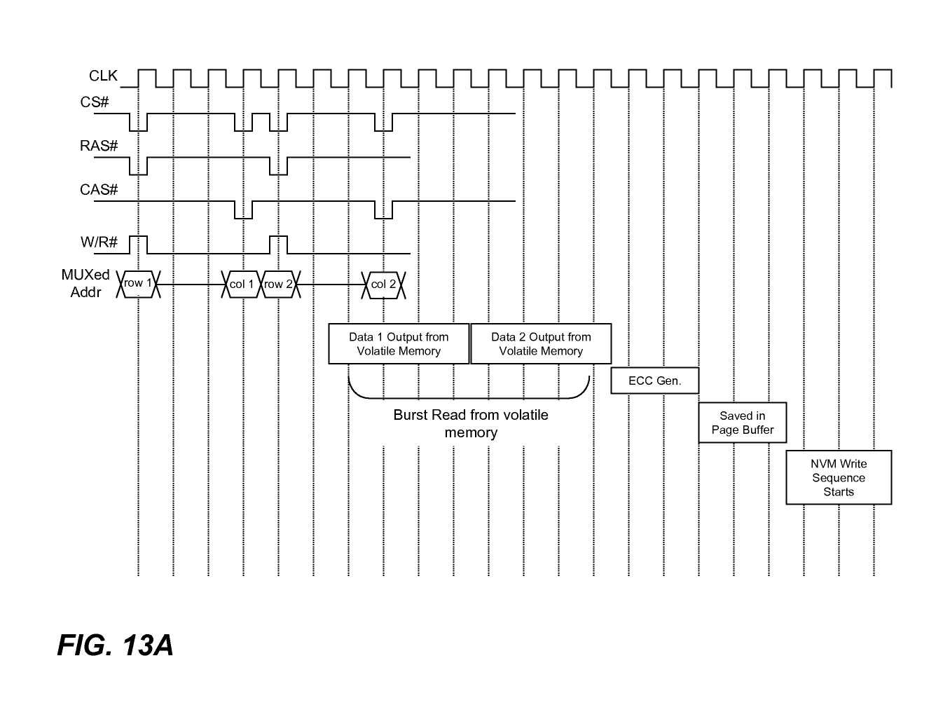

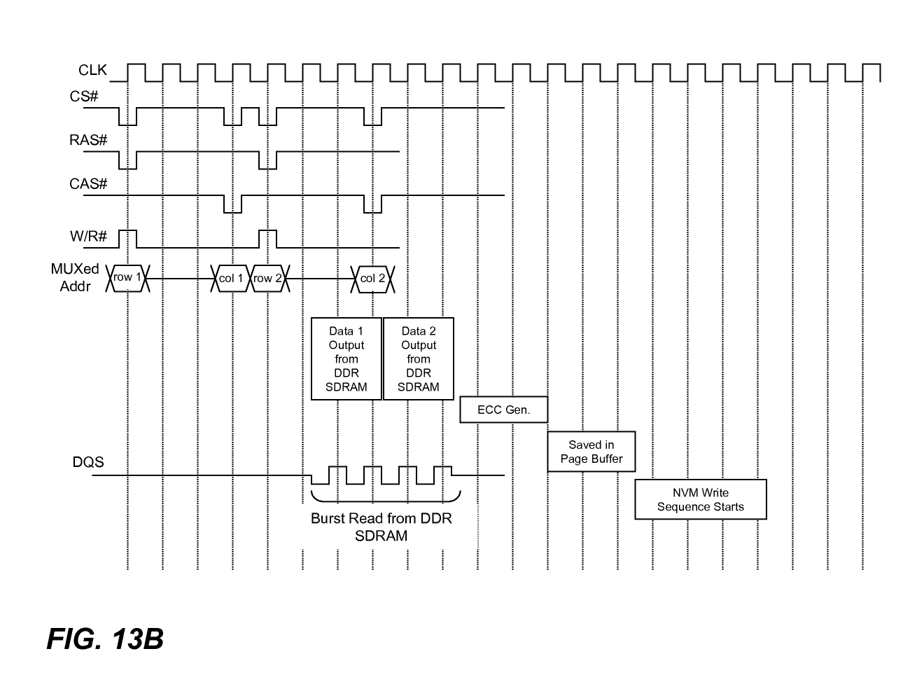

FIGS. 13A-13B are first and second waveform diagrams showing time required for performing data write operation from the volatile memory buffer to the intelligent NVM device in the first NVM based storage system 210a and the second NVM based storage system 210b, respectively.

In the first waveform diagram of FIG. 13A, chip select (CS#) is pulsed low in sync with either row address strobe (RAS#) or column address strobe (CAS#). Read/write indicator (W/R#) activates mux'ed address at ‘row 1’ and ‘row 2’. As a result, ‘data 1’ and ‘data 2’ output from volatile memory are shown with burst data read. After the data have been read, ECC generation is followed before saving to page buffers. Finally the NVM write sequence can start.

The second waveform diagram of FIG. 13B is similar to the first one. The difference is an additional DQS signal is used for burst read operation of DDR SDRAM. A different clock cycle (DQS) faster than main system clock (CLK) is used for data read operation, hence achieving a faster data access to and from the NVM device. Using DDR SDRAM as volatile memory buffer increases performance of the NVM based storage system.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas DDR SDRAM has been shown and described to be used in volatile memory buffer, other volatile memories suitable to achieve the same functionality may be used, for example, SDRAM, DDR2, DDR3, DDR4, Dynamic RAM, Static RAM. Additionally, whereas external storage interface has been described and shown as PCI-E, other equivalent interfaces may be used, for example, Advance Technology Attachment (ATA), Serial ATA (SATA), Small Computer System Interface (SCSI), Universal Serial Bus (USB), ExpressCard, fiber channel Interface, optical connection interface circuit, etc. Furthermore, whereas data security feature has been shown and described using a 128-bit AES, other equivalent or more secured standards may be used, for example, 256-bit AES. Finally, the NVM device has been shown and described to comprise two or four device, other numbers of NVM may be used, for example, 8, 16, 32 or any higher numbers that can be managed by embodiments of the present invention. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A non-volatile memory (NVM) based storage system comprising:
at least one NVM device configured for providing data storage, wherein each of the at least one NVM device includes a control interface and at least one NVM, the control interface is configured for receiving logical addresses, data, commands and timing signals, each of the logical addresses is extracted such that a corresponding physical address can be mapped into within said each of the control interface logic to perform data transfer operations, wherein the control interface further includes a wear leveling controller configured for managing wear level of the at least one NVM;
an internal bus;
at least one NVM device controller, coupled to the internal bus, each configured for controlling corresponding one of the at least one NVM device;
a data dispatcher together with the hub timing controller, configured for dispatching commands to one or more of the at least one NVM device controller;
a central processing unit (CPU), coupled to the data dispatcher, configured for control overall data transfer operations of the NVM based storage system; and
a storage protocol interface bridge, coupled to the data dispatcher, configured for receiving data transfer commands from a host computer via external storage interface.

2. The system of claim 1, further comprises a hub timing controller and a volatile memory buffer, coupled to the internal bus, wherein the hub timing controller is configured for providing timing to said each of the at least one NVM device and the volatile memory buffer is controlled by a volatile memory buffer controller.

3. The system of claim 2, further comprises a phase-locked loop circuit, coupled to the CPU, configured for providing timing clock to the volatile memory buffer.

4. The system of claim 2, wherein the volatile memory buffer is partitioned into a command queue area and a plurality of page buffers.

5. The system of claim 4, wherein the command queue is configured for storing received commands from the host computer by the storage protocol interface bridge.

6. The system of claim 4, wherein the plurality of page buffers is configured to hold transition data to be transmitted between the host computer and the at least one NVM device.

7. The system of claim 4, wherein the volatile memory buffer is configured to allow data write commands with overlapped target addresses to be merged before writing to the at least one NVM device.

8. The system of claim 4, wherein the volatile memory buffer is configured to preload data to anticipate requested data in data read commands.

9. The system of claim 4, wherein the at least one NVM device is partitioned to have a reserved area configured for storing commands and associated data in the volatile memory buffer after an unexpected power failure has been detected.

10. The system of claim 9, wherein the command queue is so sized such that the commands stored therein can be copied to the reserved area using reserved electric energy stored in a designated capacitor of the NVM based storage system.

11. The system of claim 2, wherein the volatile memory buffer comprises double data rate synchronous dynamic random access memory.

12. The system of claim 1, wherein the at least one NVM device controller are connected to a plurality of data channels such that parallel data transfer operations using interleaved memory addresses can be conducted, each of the data channels connects to at least two of the NVM devices.

13. The system of claim 1, further comprises a data encryption/decryption engine, coupled to the internal bus, configured for providing data security based on Advanced Encryption Standard.

14. A method of performing data transfer operations in a non-volatile memory (NVM) based storage system with a volatile memory buffer comprising:
receiving a data transfer command from a host computer via an external storage interface;
extracting a data transfer range from the received command;
when the received command is data read command and the data transfer range is found in the volatile memory buffer, fetching requested data from the volatile memory buffer to one or more page buffers before notifying the host computer, wherein the one or more page buffers are configured in the volatile memory buffer;
when the received command is data read command and the data transfer range is not found in the volatile memory buffer, triggering read cycles to retrieve the requested data from at least one non-volatile memory device to the one or more page buffers before notifying the host computer;
when the received command is data write command and a command queue is not full, storing the received command in the command queue, wherein the command queue is configured in the volatile memory buffer;
when the received command is data write command and the command queue is full, and the data transfer range is found in the volatile memory buffer, updating corresponding data in the one or more page buffers before writing to the at least one non-volatile memory device;
when the received command is data write command and the command queue is full, and the data transfer range is not found in the volatile memory buffer, triggering write cycles to store data to the one or more page buffers in the volatile memory buffer before writing to the at least one non-volatile memory device;
whereby the data in the one or more page buffers can be updated without writing to the at least one non-volatile memory device and the data in the one or more page buffers can be preloaded for anticipating data reading operation.

15. The method of claim 14, further comprises sending an end-of-transaction signal to the host computer after the received command has been completely stored in the command queue.

16. The method of claim 15, further comprises monitoring unexpected power failure of the NVM based storage system such that enough time is preserved for storing perishable data in a volatile memory buffer to ensure data integrity of the NVM based storage system.

17. The method of claim 16, further comprises predefining a reserved area in the at least one NVM device configured for storing commands and data in the volatile memory buffer after the unexpected power failure has been detected.

18. The method of claim 17, further comprises storing all of the stored commands that have been issued the end-of-transaction signal to the host computer, into the reserved area of the at least one non-volatile memory without performing logical-to-physical address conversion.

19. The method of claim 17, further comprises storing all of the stored commands that have been issued the end-of-transaction signal to the host computer, into the reserved area of the at least one non-volatile memory without performing logical-to-physical address conversion.

20. A method of initializing a non-volatile memory (NVM) based storage system with a volatile memory buffer comprising:
receiving a ‘recover-from-unexpected-power-failure’ command from a host computer upon powering on the NVM based storage system after an unexpected power failure;
restoring volatile memory buffer by copying stored data from a reserved area of at least one non-volatile memory device, wherein the volatile memory buffer is configured with a command queue, and one or more page buffers;
erasing the stored data from the reserved area upon completion of said restoring of the command queue and the data in the one or more page buffers; and
notifying the host computer that the NVM based storage system is in normal operating condition.

21. The method of claim 20, wherein the reserved area comprises last physical block of the at least one non-volatile memory device.
